(19) United States
(12) Patent Application Publication
(10) Pub. No.: US 2015/0037228 A1
(43) Pub. Date: Feb. 5, 2015

(54) Systems, Devices, Media, and Methods for Measuring Analytes in Biological Fluids

(71) Applicant: Sentec Pte Ltd., Singapore (SG)

(72) Inventors: Roobik AZARNIA, Miami, FL (US); Robert Allen RAY, Port Saint Lucie, FL (US)

(21) Appl. No.: 14/447,869

(22) Filed: Jul. 31, 2014

Related U.S. Application Data
(60) Provisional application No. 61/860,292, filed on Jul. 31, 2013.

(51) Int. Cl. G01N 1/28

(52) U.S. Cl. CPC G01N 1/28
USPC 422/554

(57) ABSTRACT

A replaceable cartridge for a biological analyte measurement device includes housing configured for removable engagement therefrom, and a support medium disposed within the housing. The support medium carries test pads made of a thin layer of fluid transporting material, and hermetic isolation pads made of a fluid impermeable material. The housing provides a port through which test pads are exposable to an external environment; and a set of sealing elements that define a cross sectional area within a channel internal to the housing, through which the support medium, test pads, and hermetic isolation pads are displaceable. Engagement of a hermetic isolation with the set of sealing elements results in the formation of a hermetic seal within the housing. Hermetic isolation pads can be formed as portions of cleanse pads that can be wiped across surfaces corresponding to a set of sensors, or as sealing pads separate from cleanse pads.

### TECHNICAL FIELD

An aspect of the present disclosure is directed to a cartridge that can be removably inserted into a biological analyte measurement instrument. The cartridge includes an elongate tape carrying (a) a plurality of test pads, each including a fluid transport material configured for receiving a biological fluid sample, and rapidly transporting the fluid sample within portions of the test pad; and (b) a plurality of hermetic isolation pads configured for forming a hermetic seal with a set of cartridge sealing elements. The cartridge can carry a set of sensors configured for measuring a biological analyte level within a fluid sample received by a test pad under consideration.

### BACKGROUND

Various types of test media and devices have been developed for sampling and analyzing bodily fluids that enable individuals to test bodily fluids (and in particular, their own bodily fluids) outside of a laboratory or medical setting. Examples of such test media and devices include individually packaged test strips that are exposable to a bodily fluid sample; and more economical cassettes that house an elongate test tape on which multiple testing regions reside, where each testing region on the tape is exposable to a bodily fluid sample. Individuals commonly use such media and devices to monitor their blood glucose levels.

Unfortunately, existing media and devices for sampling and analyzing bodily fluids are needlessly complex from a structural and/or mechanical standpoint, and are correspondingly undesirably costly to from a manufacturing and use standpoint. For example, U.S. Pat. No. 8,685,227 describes an elongate test tape structure that is intended to reside within a cassette, where the test tape structure has multiple test media portions disposed therealong. Each test media portion includes a pair of electrodes electrically connected to a pair of contact fields on the test media portion. The test tape structure is positionable and advanceable by way of rolling engagement between a set of rollers provided by a fluid sample testing device. Each roller includes multiple electrical contact zones for establishing electrical contact with contact fields of a given test media portion as the test tape structure is advanced by way of rotational movement of the rollers.

As another example, U.S. Pat. No. 8,021,631 describes a cassette having a housing within which uncontaminated portions of an elongate test tape reside, where the test tape includes multiple test media portions disposed therealong. The housing includes an opening through which test media portions can be withdrawn and exposed to the housing's external environment. The cassette is designed for improving the long term stability of uncontaminated test media portions within the housing by way of protecting such test media portions from humidity. In particular, the housing includes a gasket based sealing means (e.g., multiple annular gaskets). The gasket based sealing means selectively exerts a sealing force upon the test tape, for instance, at or near the housing's opening, by way of a pressure actuator such as a spring based mechanism, which can be coupled to a lever or “dancer.” By way of the gasket based sealing means, the entrance of humidity into the cassette can be minimized. U.S. Pat. No. 8,021,631 additionally describes a hydraulic sealing means, by which a flexible fluid filled pouch selectively applies pressure to the test tape to isolate uncontaminated test media from humidity.

A need exists for structurally and mechanically simple, low cost test media configured for receiving biological fluid samples. A need further exists cassette structures in which such test media reside, which include simple, low cost, reliable manners of maintaining long term test medium stability.

### SUMMARY

In accordance with an aspect of the present disclosure, a test medium for a biological fluid analyte measurement device includes: a support medium, and a plurality of test pads and a plurality of hermetic isolation pads disposed along the support medium. Each of the plurality of test pads includes a thin layer of a fluid transporting material having a length that is continuous between a first end and a second end of the test pad, a width, a thickness, and a cross sectional area defined by the width and the thickness of the test pad, where the layer of the fluid transporting material of each of the plurality of test pads includes at least one of: a fluid sampling region configured for receiving a small volume of a biological fluid sample (e.g., blood); and at least one analyte measurement region fluidically coupled to the fluid sampling region, where the at least one analyte measurement region has a length, and wherein the fluid sampling region or the at least one analyte measurement region carries at least one reagent capable of reacting with an analyte (e.g., blood glucose or blood cholesterol) that is expected to be present within the fluid sample. Each of the plurality of hermetic isolation pad includes a fluid impermeable material having a length between a first end and a second end of the hermetic isolation pad, a width, a thickness, and a cross sectional area defined by the width and the thickness of the hermetic isolation pad, wherein the cross sectional area of each of the plurality of hermetic isolation pads is greater than or equal to the cross sectional area of each of the plurality of test pads.

The fluid transporting material of each of the plurality of test pads is configured for transporting a distinct fluid sample substantially throughout the entire thickness of the fluid transporting material in the fluid sampling region of the test pad. The fluid transporting material of each of the plurality of test pads can be configured for transporting a distinct fluid sample substantially throughout the entire length of the analyte measurement region of the test pad, or substantially throughout the entire test pad.

Depending upon embodiment details, the fluid sampling region of each of the plurality of test pads can have a length that spans a predetermined fraction of the test pad length away from the first end of the test pad, or a length that spans a predetermined fraction of the test pad length in a segment of the test pad between the first end of the test pad and the second end of the test pad.

Each of the plurality of hermetic isolation pads can include or be a cleanse-sealing pad including a material configured for wiping, absorbing, or wicking portions of a distinct fluid sample away from a surface or structure when wiped across the surface or structure, and wherein each cleanse-sealing pad is disposed adjacent to a test pad.

Some embodiments include a plurality of cleanse pads distinct from the plurality of hermetic isolation pads, where each of the plurality of cleanse pads includes a material configured for wiping, absorbing, or wicking portions of a distinct fluid sample away from a surface or structure when wiped across the surface or structure, wherein each cleanse pad is disposed adjacent to a test pad and/or adjacent to a hermetic isolation pad.

The plurality of test pads can include a first set of test pads and a second set of test pads distinct from the first set of test pads, where each test pad within the first set of test pads carries a first reagent capable of reacting with a first analyte that is expected to be present within the fluid sample, and each test pad within the second set of test pads carries a second reagent capable of reacting with a second analyte that is expected to be present within the fluid sample and which is different than the first analyte. In some embodiments, the number of test pads within the first set of test pads significantly exceeds the number of test pads within the second set of test pads. Alternatively, each test pad within the plurality of test pads can carry a first reagent capable of reacting with a first analyte and a second reagent capable of reacting with a second analyte different than the first analyte.

In several embodiments, the support medium includes or is an elongate tape structure, for instance, having a continuous length of the fluid transporting material between at least a first test pad and a last test pad of the plurality of test pads. In such embodiments, the support medium includes a plurality of separation elements, where each of the plurality of separation elements is positioned between a pair of test pads, and each of the plurality of separation elements includes a portion of the fluid transporting material that has been rendered fluid nontransporting or hydrophobic.

In multiple embodiments, the tape structure includes a support layer having a continuous length between at least a first test pad and a last test pad of the plurality of test pads, wherein each of the plurality of test pads and each of the plurality of hermetic isolation pads is disposed on the support medium. The support layer can include a first side and a second side along its length, wherein the first side of the support layer carries an adhesive film to which at least a portion of each of the plurality of test pads is adhered.

In certain embodiments, the elongate tape structure can carry (a) a plurality of cleanse pads and/or cleanse-sealing pads disposed directly adjacent one another along a terminal end section of the elongate tape structure, or (b) an extended length cleanse pad or cleanse-sealing pad disposed at the terminal end section of the elongate tape structure.

In a number of embodiments, the fluid sampling region of each of the plurality of test pads need not be or is not adhered to the support medium, but the analyte measurement region of each of the plurality of test pads is adhered to the support medium.

The support medium can include or be a structure having a circular profile or cross section.

In several embodiments, the support medium includes a plurality of indexing holes, wherein each of the plurality of indexing holes is configured for receiving an indexing pin.

In accordance with an aspect of the present disclosure, a test medium for a biological fluid analyte measurement device includes a support medium that carries a plurality of test pads and a plurality of cleanse pads disposed therealong. Each test pad includes a thin layer of a fluid transporting material having a length that is continuous between a first end and a second end of the test pad, a width, a thickness, and a cross sectional area defined by the width and the thickness of the test pad, where the layer of the fluid transporting material of each of the plurality of test pads includes at least one of: a fluid sampling region configured for receiving a small volume of a biological fluid sample; and at least one analyte measurement region fluidically coupled to the fluid sampling region, wherein the at least one analyte measurement region has a length, and wherein the fluid sampling region or the at least one analyte measurement region is pre-loaded with at least one reagent capable of reacting with an analyte that is expected to be present within the fluid sample. Each of the plurality of cleanse pads is disposed along the support medium such that each cleanse pad is located between a pair of test pads. Each of the plurality of cleanse pads has a length between a first end and a second end of the cleanse pad, a width, a thickness, and a cross sectional area defined by the width and the thickness of the cleanse pad, wherein the cross sectional area of each of the plurality of cleanse pads is greater than or equal to the cross sectional area of each of the plurality of test pads, wherein each of the plurality of cleanse pads is not pre-loaded with the at least one reagent, and wherein each of the plurality of cleanse pads includes a material capable of wiping, absorbing, or wicking portions of the distinct fluid sample away from a surface corresponding to a set of sensors when wiped across the surface corresponding to the set of sensors in association with displacement of the support medium in a forward motion direction. The support medium includes (a) a structure to which portions of test pads and/or cleanse pads are adhered, or (b) a structure made from the fluid transporting material and which has been rendered fluid nontransporting or hydrophobic at predetermined locations.

In accordance with an aspect of the present disclosure, a replaceable cartridge for a biological analyte measurement device includes a support medium that carries a plurality of test pads and a plurality of hermetic isolation pads; and a housing in which the support medium resides, where the housing is removably engageable with the analyte measurement device. More particularly, the support medium is displaceable in a forward motion direction by way of a set of mechanical drive elements. Each of the plurality of test pads is positionable relative to a set of sensors. Each of the plurality of test pads includes or is a thin layer of a fluid transporting material having a length that is continuous between a first end and a second end of the test pad, a width, a thickness, and a cross sectional area defined by the width and the thickness of the test pad, where the layer of the fluid transporting material of each of the plurality of test pads includes at least one of: a fluid sampling region configured for receiving a small volume of a biological fluid sample, and at least one analyte measurement region corresponding to the fluid sampling region and carrying at least one reagent capable of reacting with an analyte that is expected to be present within the fluid sample, where the at least one analyte measurement region has a length, wherein the fluid sampling region or the at least one analyte measurement region carries at least one reagent capable of reacting with an analyte that is expected to be present within the fluid sample. Each of the plurality of hermetic isolation pads is located between a pair of test pads, and includes a fluid impermeable material. Each of the plurality of hermetic isolation pads has a length between a first end and a second end of the hermetic isolation pad, a width, a thickness, and a cross sectional area defined by the width and the thickness of the hermetic isolation pad, wherein the cross sectional area of each of the plurality of hermetic isolation pads is greater than or equal to the cross sectional area of each of the plurality of test pads. The housing includes a plurality of internal surfaces providing a primary channel having a primary cross sectional area through which the support medium, each of the plurality of test pads, and each of the plurality of hermetic isolation pads are displaceable. The housing carries at least one set of sealing elements that occupies a portion of the primary cross sectional area along a portion of the primary channel to define a secondary channel through which the support medium, each of the plurality of test pads, and each of the plurality of hermetic isolation pads are displaceable, where the secondary channel has a secondary cross sectional area smaller than the primary cross sectional area, and wherein the at least one set of sealing elements is engageable with each of the plurality of hermetic isolation pads when the hermetic isolation pad is displaced through portions of the secondary channel. The housing provides a port through which each of the plurality of test pads is exposable to an environment external to the housing. Engagement of a hermetic isolation pad of the plurality of hermetic isolation pads with the at least one set of sealing elements enables the formation of a hermetic seal within the housing that isolates portions of the primary channel from the environment external to the housing.

In various embodiments, the at least one set of sealing elements can include a first set of sealing elements disposed proximate to the port and/or the set of sensors. In some embodiments, the at least one set of sealing elements includes a first set of sealing elements disposed at a first predetermined location relative to the primary channel, and a second set of sealing elements disposed at a second predetermined location relative to the primary channel, wherein the first set of sealing elements resides closer to the port than the second set of sealing elements. The first set of sealing elements can be configured for engaging with a first hermetic isolation element of the plurality of hermetic isolation elements, and the second set of sealing elements can be configured for engaging with a second hermetic isolation element of the plurality of hermetic isolation elements distinct from the first hermetic isolation element.

In multiple embodiments, the cartridge includes a set of sensors carried by the housing (although in some embodiments the set of sensors can alternatively or additionally be external to the cartridge, e.g., carried by the analyte measurement device). The set of sensors is configured for detecting the presence or level of at least one analyte within a distinct fluid sample transported from the fluid sampling region of a test pad of the plurality of test pads into the at least one analyte measurement region of the test pad. The cartridge, including a set of sensors carried thereby, is disposable. The set of sensors includes an electrochemical sensor, an electrochemiluminescence sensor, and/or an optical sensor. In certain embodiments, the set of sensors includes a first sensor and a second sensor that operates in accordance with a different sensing modality than the first sensor.

In several embodiments, each of the plurality of hermetic isolation pads includes or is a cleanse-sealing pad disposed adjacent to a test pad, where each of the cleanse-sealing pads includes a material configured for wiping, absorbing, or wicking portions of the distinct fluid sample away from a surface corresponding to the set of sensors when wiped across the surface corresponding to the set of sensors.

Some embodiments include a plurality of cleanse pads distinct form the plurality of hermetic isolation pads, where each of the plurality of cleanse pads is disposed adjacent to a test pad and/or adjacent to a hermetic isolation pad. Each plurality of cleanse pads includes a material configured for wiping, absorbing, or wicking portions of a distinct fluid sample away from a surface corresponding to the set of sensors when wiped across the surface corresponding to the set of sensors.

The cartridge can include at least one desiccant material carried or disposed within the housing.

The support medium is configured for indexed displacement in the forward motion direction by way of the set of mechanical drive elements. In several embodiments, the cartridge carries passive mechanical drive elements and excludes active mechanical drive elements configured to drive the passive drive elements (i.e., the passive mechanical drive elements are driven by the active mechanical drive elements, which can be provided by the analyte measurement device).

The support medium can include or be an elongate tape structure, or a structure having a circular profile or cross section. When the support medium includes an elongate tape structure, the replaceable cartridge further includes a source compartment in which test pads of the plurality of test pads that have not been exposed to the external environment reside, and a destination compartment in which test pads of the plurality of test pads that have been exposed to the external environment can be transferred or reside. Successive indexed displacement of the support medium in the forward motion direction successively transfers test pads from the source compartment into the primary channel of the replaceable cartridge. Correspondingly, such successive indexed displacement moves used test pads (and hermetic isolation pads and any cleanse pads, if present) into the destination compartment.

A destination spool can be disposed in the destination compartment, around which the tape structure can be wound in association with displacement of the tape structure in the forward motion direction. A source spool can optionally be disposed in the source compartment, around which the tape structure is wound and from which the tape structure can be fed into the primary channel of the replaceable cartridge in association with displacement of the tape structure in the forward direction.

### BRIEF DESCRIPTION OF THE DRAWINGS

FIG. 1 is a schematic illustration of an analyte measurement system or apparatus in accordance with a representative embodiment of present disclosure, which includes a disposable or replaceable cartridge configured for mating engagement with and disengagement from an analyte measurement device.

FIG. 2A is schematic illustration of a continuous medium in the form of a test tape carrying test pads and cleanse-sealing pads in accordance with an embodiment of the present disclosure.

FIG. 2B is a schematic illustration of a cartridge carrying the test tape of FIG. 2A, where the cartridge includes a set of sealing elements in accordance with an embodiment of the present disclosure.

FIG. 2C is a schematic illustration of a cartridge in which a test tape carrying test pads and cleanse-sealing pads in accordance with another embodiment of the present disclosure resides.

FIG. 2D is a schematic illustration of a cartridge carrying the test tape of FIG. 2A, wherein the cartridge includes multiple sets of sealing elements in accordance with an embodiment of the present disclosure.

FIG. 2E is a schematic illustration of a primary cross sectional area provided by a primary channel within a cartridge, and a secondary cross sectional area corresponding to a secondary channel disposed within the primary channel in accordance with an embodiment of the present disclosure.

FIG. 2F is a schematic cross sectional illustration of a representative test pad disposed within the secondary cross sectional area of FIG. 2E.

FIG. 2G is a schematic cross sectional illustration of a representative cleanse-sealing pad disposed within the secondary cross sectional area of FIG. 2E for purpose of forming a hermetic seal when engaged with a set of structural sealing elements that define the secondary cross sectional area in accordance with an embodiment of the present disclosure.

FIG. 2H is a schematic illustration of a representative test tape that carries test pads, cleanse pads, and distinct/dedicated sealing pads in accordance with an embodiment of the present disclosure.

FIG. 3A is a schematic illustration of a representative test tape cartridge according to an embodiment of the present disclosure.

FIG. 3B is a perspective view of the cartridge of FIG. 3A.

FIG. 3C is a schematic illustration of a representative test tape cartridge that carries a set of passive/secondary drive elements which can be driven by a set of active/primary drive elements provided by an analyte measurement device when the cartridge is engaged with the analyte measurement device in accordance with an embodiment of the present disclosure.

FIG. 4 is a top view schematically illustrating portions of a test tape disposed within portions of a cartridge in accordance with another embodiment of the present disclosure.

FIGS. 5A and 5B are schematic illustrations of a continuous medium in the form of a test tape carrying test pads, cleanse pads, and separation/sealing members in accordance with an embodiment of the present disclosure.

FIGS. 6A and 6B are schematic illustrations of a representative positioning of a set of sensors relative to a continuous medium in the form of a test tape that includes test pads, cleanse-sealing pads, and separation members in accordance with an embodiment of the present disclosure.

FIGS. 7A and 7B are schematic illustrations of a continuous medium in the form of a test tape carrying test pads, cleanse-sealing pads, and separation members in accordance with yet another embodiment of the present disclosure.

FIG. 8A is a schematic illustration of a representative set of sensors having multiple distinct types of sensors or sensing elements, and a positioning of a representative test tape carrying test pads and cleanse-sealing pads relative thereto, in accordance with an embodiment of the present disclosure.

FIG. 8B is a schematic illustration of a representative sensing element disposed within a spatial extent of a port structure of a cartridge, and a representative positioning of a test pad relative thereto in accordance with an embodiment of the present disclosure.

FIG. 9A is a schematic illustration of a continuous medium in the form of a test tape carrying test pads configured for measuring different or multiple types of analytes in accordance with an embodiment of the present disclosure.

FIG. 9B is a schematic illustration of a continuous medium in the form of a test tape carrying test pad pairs that are separated by cleanse-sealing pads in accordance with another embodiment of the present disclosure.

FIG. 10 is a schematic illustration of a continuous medium in the form of a disk carrying test pads and cleanse pads in accordance with an embodiment of the present disclosure.

### DETAILED DESCRIPTION

Examples of embodiments in accordance with the present disclosure described herein are non-limiting representative examples that are provided for purpose of aiding clarity and understanding. Additional or other embodiments or embodiment details not expressly described herein that conform to the fundamental structural and/or functional principles of embodiments described herein fall within the scope of the present disclosure.

In the present disclosure, the depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. Additionally, unless explicitly stated otherwise, in the description herein, the use of the term “approximately” or “substantially” with respect to an object, element, structure, or parameter is taken to mean within a range of +/−20%, +/−10%, or +/−5% relative to the entirety of the object, element, structure, or parameter, respectively. Similarly, the recitation of particular numerical values or value ranges is taken to be a recitation of particular approximate numerical values or approximate value ranges (e.g., within +/−20%, or +/−10%, or +/−5%).

As used herein, the term “set” corresponds to or is defined as a non-empty finite organization of elements that mathematically exhibits a cardinality of at least 1 (i.e., a set as defined herein can correspond to a singlet or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, a structural feature, an object, a material, a substance, a process, a physical parameter, or a value, depending upon the type of set under consideration.

Overview

Embodiments in accordance with the present disclosure are directed to manual, semi-automated, or automated systems, apparatuses, instruments, structures, devices, and media for (a) receiving a small volume of a liquid as a fluid sample, which is typically a biological fluid such as (but not limited to) whole blood or plasma; and (b) detecting the presence or estimating/measuring the level or quantity of one or more analytes in the received fluid sample.

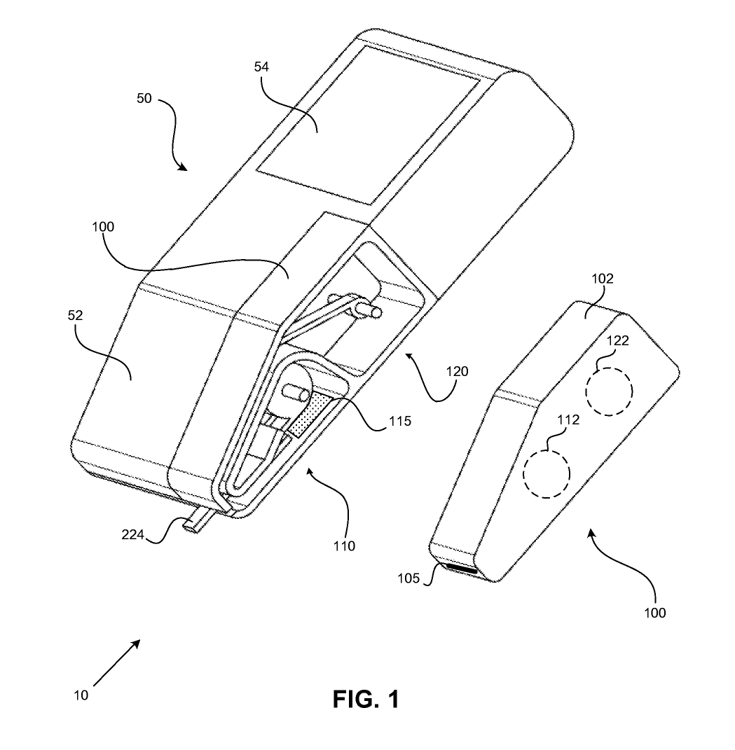

FIG. 1 is a schematic illustration of an analyte detection, measurement, metering, or monitoring system or apparatus 10 in accordance with a representative embodiment of present disclosure, which includes a disposable or replaceable cassette, magazine, or cartridge 100 that can be removably or matingly engaged with a portion of a body 52 of an analyte meter or measurement instrument or device 50. As the fluid sample in most embodiments is a biological fluid sample, the analyte measurement device 50 is correspondingly a biological analyte measurement device 50.

Depending upon embodiment details, the analyte measurement device 50 can include a visual display device 54 such as an LCD screen carried by its body 52, or exclude a visual display device 54. Internally, the analyte measurement device 50 typically includes processing resources (e.g., a processing unit), data storage resources (e.g., a memory, in which program instructions that are executable by the processing unit can be stored), as well as power resources (e.g., a battery) and signal transfer/communication resources, in a manner readily understood by one of ordinary skill in the relevant art. In certain embodiments (e.g., in which a visual display device 54 is not carried by the analyte measurement device's body 52), the analyte measurement device 50 is configured for communicating (e.g., by way of wireless and/or wire-based signal transfer) analyte measurement results to a separate or remote display/processing system, device, or station having processing, memory, and communication resources, for instance, one or more non-portable and/or portable/mobile electronic or computing devices, such as a desktop, laptop, or tablet computer, or a smart phone.

In a representative embodiment, the analyte measurement apparatus 10 and/or the cartridge 100 are configured for detecting, estimating, or measuring blood glucose levels (e.g., the analyte measurement device 50 includes or is a blood glucose monitor). In other embodiments, the analyte measurement apparatus 10 and/or the cartridge 100 can be additionally or alternatively configured for detecting, estimating, or measuring the levels of one or more other analytes, such as blood cholesterol.

As further described in detail below, the cartridge 100 includes a housing 102 that carries a continuous, essentially continuous, or substantially continuous test medium such as an elongate tape/ribbon/band; a structure having a partial or complete elliptical or circular profile or cross section, such as a disk, platter, ring, or cylinder/drum or a portion thereof, on or along which multiple distinct or distinguishable test zones, sites, elements, members, materials, media, or pads are disposed. The test medium can be advanced, such as by way of indexed displacement, through an internal cross sectional area of the housing 102 that is formed or defined by a plurality of internal surfaces of the housing, as described in greater detail below.

The continuous medium carries, includes, or has formed thereon/therein (e.g., integrally formed therein) particular types of pad elements, including test pads configured for analyte detection/analyte level measurement. In representative embodiments, between 5-100 test pads, e.g., between 10-50 test pads, or between 10-20, 25, or 30 test pads, can be carried by the continuous medium. Each test pad includes or is a generally thin, thin, or very thin layer of at least one fluid transport material or medium that can communicate, transport, distribute, spread, or deliver a fluid sample to which the test pad is exposed into, within, across, and/or at throughout portions of the test pad or substantially the entire test pad (e.g., at least 75%-95% or more of the test pad's surface area or volume). Such fluid transport can be facilitated or occur by way of absorption, wicking/capillary action, surface or surface tension effects, adhesive and/or adsorptive forces, interfacial forces/effects, and/or another type of fluid transport mechanism (e.g., diffusion). The fluid sample is typically volumetrically small or very small, for instance, less than or equal to approximately 0.5-2 microliters.

Any given test pad can be loaded (e.g., pre-loaded) with one or more reagents or reagent formulations (e.g., at least one reagent in wet or dry form) to facilitate the detection or measurement of at least one analyte in a fluid sample to which the test pad is exposed. In a representative embodiment, a reagent formulation suitable for measuring blood glucose levels includes the enzyme glucose oxidase, glucose dehydrogenase, or hexokinase; potassium hexacyanoferrate(III); a buffer and/or stabilizer such as sodium benzoate, gentamycin sulfate, or dipotassium EDTA; one or more salts; polymers such as polyvinyl alcohol and/or polyvinylpyrrolidine; and one or more additives/surfactants such as Triton-X100.

In general, each test pad is formed from one or more types of non-fibrous and/or fibrous materials that facilitate or enable rapid and uniform transport of a fluid sample to, into, and through or throughout substantial portions of an “active area” of the test pad that carries a set of reagents, and within which a chemical reaction (e.g., a biochemical reaction) can occur. Analyte measurement is intended to occur relative to or within the test pad's active area. Depending upon embodiment details, a test pad's active area can encompass essentially the entire overall surface area of the test pad, or a portion thereof.

In a number of embodiments, the test pads include or are formed from one or more types of natural and/or synthetic fibrous materials (e.g., textile materials). In representative embodiments, suitable natural fibrous materials from which test pads can be or are formed include fibers formed from cellulose, lignin, cotton, hemp, jute, flax, ramie, sisal, bagasse, silkworm silk, spider silk, sinew, catgut, wool, sea silk, mineral fibers, or other natural fibers; and suitable synthetic fibrous materials include synthetic fibers formed from regenerated natural cellulose, and synthetic polymer fibers such as nylon, polyester, vinylon, vinyon, olefin fiber, polyester, polyurethane, or other synthetic fibers. Depending upon embodiment details, the material(s) from which the test pads are made can be unmodified, modified, untreated, treated, unpatterned, patterned (e.g., test pads can include a micropatterned superhydrophobic textile (MST)), untextured, textured, or microscale/nanoscale structured.

The cartridge 100 includes, provides, or facilitates test pad access to a port or aperture 105, relative to which a portion of each test pad along the continuous medium can be selectively presented or exposed (e.g., to an external environment) for receiving a fluid sample. Such access occurs by way of advancement of the test medium through the aforementioned cross sectional area within the housing. In several embodiments, the cartridge 100 carries a set of sensors (e.g., at least one of an electrochemical, electrochemiluminescence (ECL), or optical sensor, or a combination thereof) configured for detecting or measuring the presence or level of at least one analyte within a fluid sample transferred to/received by the active area of a test pad under consideration (e.g., a test pad that is currently positioned for receiving the fluid sample by way of the port 105). Thus, in a number of embodiments, the set of sensors is disposed within the cartridge 100, and hence replacement of the cartridge 100 automatically or inherently results in replacement of the set of sensors carried thereby, in contrast to particular types of prior analyte metering systems or devices in which a sensor is integrated with a meter body and the sensor may not be readily replaceable, or readily upgradeable in accordance with advances in sensor technology. Depending upon the type(s) of sensor(s) carried by the cartridge, test pad active areas can be positioned directly in contact with one or more sensors or sensing elements (e.g., electrodes), or proximate/adjacent to one or more sensors or sensing elements (e.g., a photodetector/photodiode), in a manner readily understood by one having ordinary skill in the relevant art. In other embodiments, the set of sensors can alternatively or additionally be carried by the body 52 of the analyte measurement device 50.

In addition to the test pads, embodiments in accordance with the present disclosure include other types of pad elements disposed on or along portions of the continuous medium, which can be configured for cleaning/wiping purposes and/or hermetic seal formation purposes. For instance, various embodiments include multiple distinct or distinguishable cleanse, cleaning, or wiping zones, sites, elements, members, media, materials, or pads disposed on or along the continuous medium, such that the test pads and the cleanse pads are disposed in a predetermined sequence (e.g., an alternating sequence) with respect to each other. Test pads and cleanse pads can be spaced apart from each other by a gap and/or a separating element, member, structure, material, or medium. After a portion of a test pad that has received a fluid sample has been positioned against or adjacent to a sensor and the sensor has generated a signal corresponding to the level of an analyte of interest within the fluid sample, the continuous medium can be displaced such that the test pad is moved away from the sensor, and a cleanse pad is moved across or along the sensor to facilitate sensor cleaning or wiping (e.g., such that the cartridge 100 is self-cleaning with respect to the set of sensors). Depending upon embodiment details, cleanse pads can be formed from materials that are identical to or substantially identical to the material(s) from which test pads are formed (e.g., synthetic or natural fibrous material(s)); or different from the material(s) from which test pads are formed (e.g., foam-based and/or sponge-like material(s)).

In multiple embodiments, portions of the cartridge 100 and/or the continuous medium carry one or more types of sealing or isolation zones, sites, elements, members, features, media, or materials configured for isolating or essentially isolating unused or fresh test pads that have not been advanced to the port 105 and which are not exposable to a fluid sample by way of the port 105 from substances (e.g., moisture) that may be present in an external environment to which the port 105 is exposed or exposable. Such sealing/isolation features facilitate the maintenance of a controlled internal environment within the region(s) of the cartridge 100 in which the fresh test pads reside. Sealing/isolation features can include or be made from one or more types of resilient materials that are deformable/compressible or at least slightly deformable/compressible, which can block, prevent, or essentially prevent the passage of fluids/gases such as air and moisture within the air. For instance, sealing/isolation features can include non-fibrous materials such as rubber and/or sponge-like materials capable of forming a hermetic seal. In various embodiments, sealing/isolation features carried by the continuous medium include pad elements that can be referred to as hermetic isolation pads. In some embodiments, hermetic isolation pads can be formed from or integral with portions of the cleanse pads. However, in other embodiments, the continuous medium can carry hermetic isolation pads as sealing pads that are distinct from test pads and cleanse pads carried by the continuous medium, where the sealing pads facilitate the formation of a fluid (e.g., air and moisture) impermeable or essentially fluid impermeable seal between the port 105 internal portions of the cartridge 100 that contain fresh/unused test pads that have not yet reached the port 105. In certain embodiments, the continuous medium carries each of test pads, cleanse pads, and distinct/dedicated sealing pads, for instance, disposed in a predetermined sequence (e.g., a repeating sequence of test pad-cleanse pad-sealing pad triplets) upon or along the continuous medium. In specific embodiments, the continuous medium carries test pads and distinct/dedicated sealing pads (e.g., arranged in an alternating sequence relative to each other along the continuous medium), but omits cleanse pads.

Thus, in view of the foregoing, in various embodiments in accordance with the present disclosure, the test medium includes multiple types of pad elements including test pads, and cleanse-sealing pads, or cleanse pads plus distinct sealing pads. The test medium can be selectively or selectably displaced or advanced such that any given pad element can be displaced toward, to, and past the set of sensors and the port 105.

More particularly, in several embodiments the cartridge 100 includes a set of mechanical elements configured for controlling the selective/selectable positioning or advancement of the continuous medium relative to the port 105 (e.g., for controlling the selective advancement of test pads and cleanse pads toward, to, and past the port 105). Such mechanical advancement elements are typically configured for indexing or stepwise displacing the continuous medium in an advancement/forward or forward motion/next-available unused test pad to port alignment direction by a predetermined distance (e.g., corresponding to a predetermined separation distance between pad elements, for instance, a predetermined distance between test pads and cleanse pads, and/or a predetermined distance between cleanse pads and sealing pads). In a number of embodiments in which the continuous medium exhibits the form of a tape, the mechanical advancement elements can include a source carrier, spool, roller, or wheel 112 around or about which portions of the continuous medium carrying fresh test pads are disposed, and/or a destination carrier, spool, roller, or wheel 122 around or about which portions of the continuous medium carrying used test pads can be disposed. The source spool 112 if present can reside in a source compartment 110, and the destination spool 122 can reside within a destination compartment 120 of the cartridge 100. Some embodiments in which the continuous medium is in the form of a tape can omit or exclude a source spool 112 and/or a destination spool 122 (e.g., the tape can be folded/foldable, such that it can be drawn from the source compartment 110 by way of unfolding, and/or fed into the destination compartment 120 in a manner that involves (re)folding of tape segments, and possibly stacking such (re) folded tape segments). In embodiments in which the continuous medium exhibits a circular cross sectional area, such as the form of a disk or cylinder, the mechanical advancement elements can include a shaft having a gear or other type of mechanical interface structure configured for communicating or imparting rotational movement to the disk/cylinder.

In addition to the foregoing, internal portions of the cartridge 100 in which fresh test pads reside can carry or incorporate a set of moisture-absorbing materials 115 such as one or more types of desiccants, for instance, which can be sprayed onto or otherwise disposed in or applied to particular internal portions of the cartridge 100, and/or carried, secured, or adhered in packet form to certain internal portions of the cartridge 100. In some embodiments, one or more portions of the cartridge 100 can include or be made from a polymer or plastic material having desiccant material(s) incorporated therein.

Particular aspects of representative analyte detection/measurement/metering/monitoring systems or devices in accordance with particular embodiments of the present disclosure are described in detail hereafter.

Aspects of a Representative Test Tape Embodiment

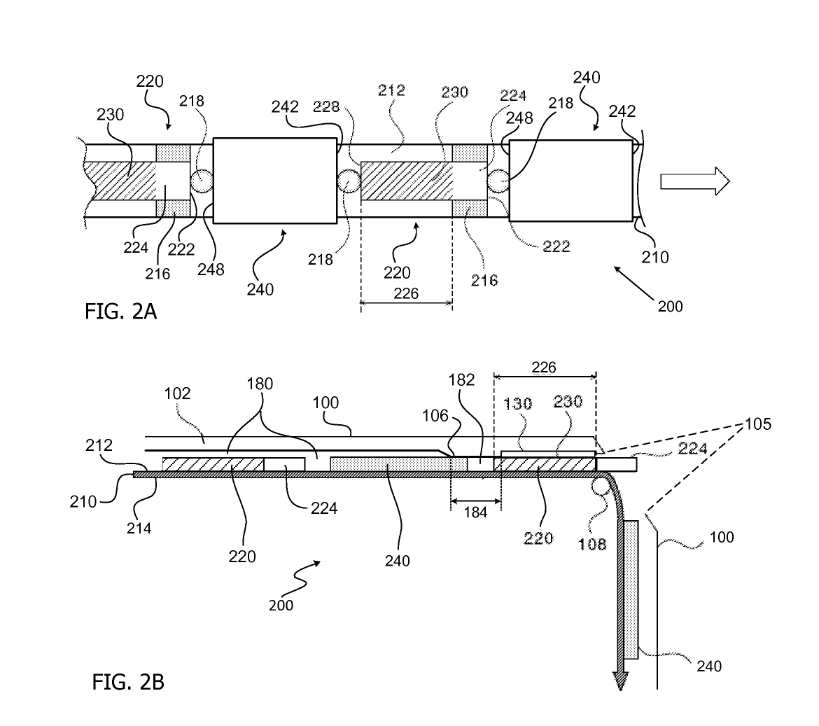

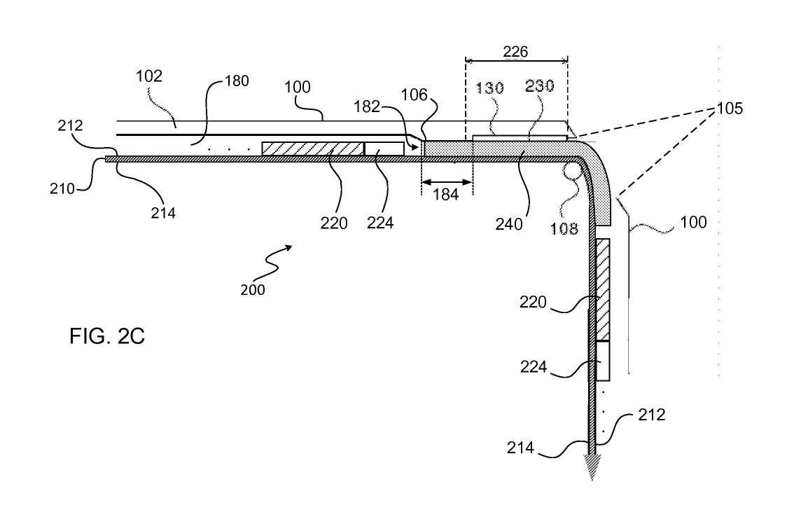

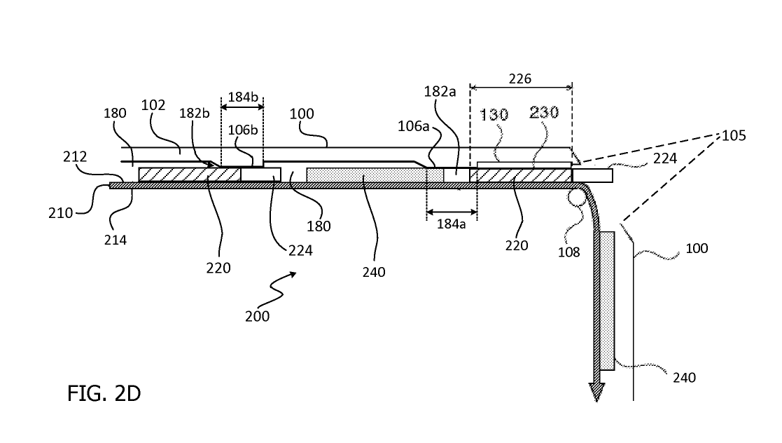

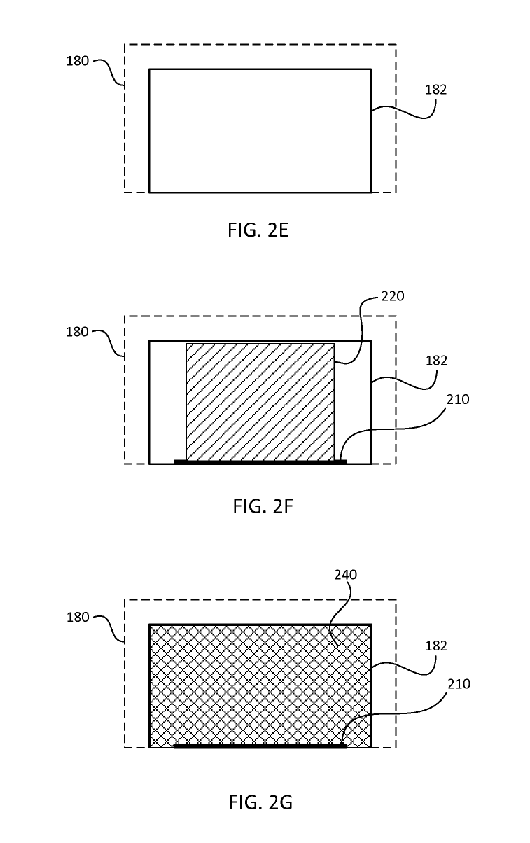

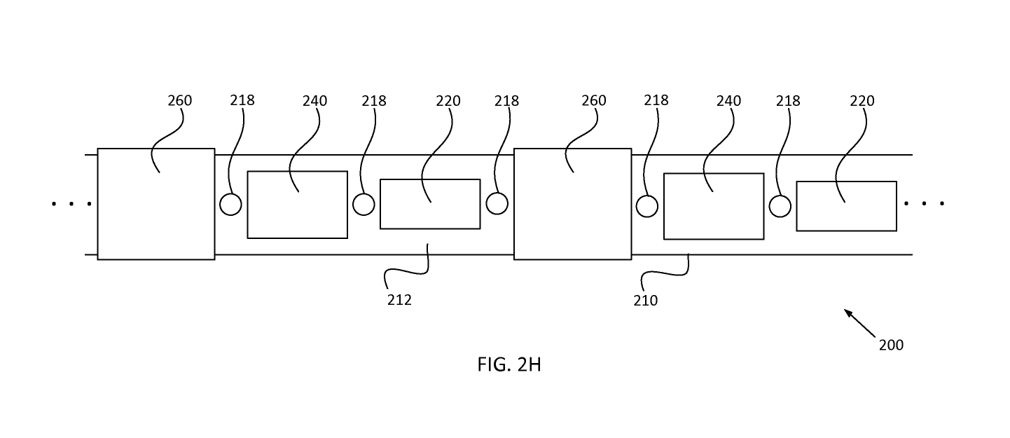

FIGS. 2A-2C are schematic illustrations of a continuous, substantially continuous, or approximately continuous medium that carries test pads and cleanse capable pads, where the continuous medium exhibits the form of a test tape structure or test tape 200 in accordance with an embodiment of the present disclosure. In the embodiment shown in FIGS. 2A-2C, the test tape 200 is a stacked or multi-layered structure that includes a substrate or support member or layer 210, on or along which multiple test pads 220 and multiple cleanse pads or cleanse capable pads 240 (e.g., cleanse-sealing pads 240, as further detailed below) are disposed or disposable. The support layer 210 forms a thin, flexible elongate strip of material having a first, top, or upper side or surface 212; and a second, bottom, or under side or surface 214. In a representative embodiment, the support layer can be 10-100 cm long, 2-4 mm wide, and 1-5 mils thick, and the support layer can be made from one or more of polyester, polypropylene, polyethelene, polyethylene-polypropylene co-polymer, ultra-high molecular weight (UHMW) polyethylene, polyvinyl chloride, polyimide (e.g., Kapton®), polytetrafluroethylene (PTFE), polyvinyl alcohol, polyurethane, polyvinyl fluoride, and other materials or material compositions.

The support layer's upper side 212 includes at least one adhesive material, layer, or film disposed thereon, which generally or preferably exhibits a fluid nontransporting and/or hydrophobic nature. Each test pad 220 and each cleanse pad 240 is disposed on the support layer's upper side 212, and is held or retained in place on the upper side 212 by way of this adhesive film. In a representative embodiment, the adhesive layer can be formed from one or more types of glue, cement, mucilage, or paste, such as an animal based glue (e.g., a collagen based adhesive, an albumin glue, casein glue, or a meat glue), a plant based glue (e.g., a natural resin such as Canada balsam, pine rosin, gum Arabic or postage stamp gum), latex, a starch or starch based glue (e.g., library paste), methyl cellulose, mucilage, resorcinol resin, or urea-formaldehyde resin), a solvent-type glue (e.g., polystyrene cement/Butanone or dichloromethane), a synthetic monomer glue (e.g., acrylonitrile, cyanoacrylate, an acrylic glue, or resorcinol glue), a synthetic polymer glue (e.g., an epoxy resin or putting, ethylene-vinyl acetate, phenol formaldehyde resin, polyamide, polyester resin, polyethylene, polypropylene, polysulfides, polyurethane, polyvinyl acetate, polyvinyl alcohol, polyvinyl chloride, polyvinyl chloride emulsion, polyvinyl pyrrolidone, rubber cement, or silicones), or another type of material or material composition.

In general, the support layer 210 has an overall length that is much greater than the length of any given test pad 220 or cleanse pad 240, such that a significant number of test pads 220 and cleanse pads 240 (e.g., many, or typically up to 25-100 of each) can be disposed along the support layer's overall length. Each test pad 220 has a predetermined length between a first end 222 and a second end 228 of the test pad 220 along a small segment of the support layer's overall length. Each test pad 220 additionally has a predetermined width, which in the embodiment of FIG. 2A is at least slightly narrower than the width of the support layer 210. In other embodiments, test pads 220 have a width that is substantially or essentially identical to that of the support layer 210, and in certain embodiments test pads 220 can have a width that is greater than that of the support layer 210. In several embodiments, each test pad 220 has an elongate shape. For instance, in the embodiment shown in FIGS. 2A-2C, each test pad 220 has a length that is greater or significantly greater than its width. That is, referenced relative to the longitudinal extent or elongate length of the test tape 200, the length or longitudinal extent of a test pad 220 is greater than the width or transverse extent of the test pad 220. In a representative embodiment, a test pad 220 can be between 2-8 mm long, and 1-4 mm wide. An individual having ordinary skill in the relevant art will understand that test pads 220 need not be elongate in other embodiments (e.g., in such embodiments, the length of a test pad 220 can be less than or equal to its width).

Any given test pad 220 includes or is a thin or very thin layer of fluid transport material(s), such as one or more types of fibrous and/or non-fibrous, typically flexible materials. In the embodiment of FIGS. 2A-2C, the test pad's first end 222 corresponds to a fluid sampling region 224 at which the test pad 220 is exposable or exposed to a fluid sample (e.g., when the test pad 220 is appropriately positioned relative to the port 105). In response to receipt of or contact with a fluid sample at its fluid sampling region 224, the test pad 220 rapidly distributes or transports the received fluid sample at least substantially throughout an active area or analyte measurement region 230 of the test pad 220. Fluid distribution or transport within, along, and/or across the test pad 220 can occur by way of one or more mechanisms, such as absorption, wicking, and or another type of fluid transport action, in a manner readily understood by one having ordinary skill in the relevant art.

Depending upon embodiment details, a test pad's active area 230 can span or encompass the entire or essentially the entire length or surface area of test pad 220, or a portion thereof. The active area 230 is pre-loaded with one or more reagents to facilitate the detection and measurement of one or more specific analytes. When a test pad 220 is positioned relative to the port 105 for receiving a fluid sample, the location of its active area 230 corresponds to the location or position of at least one sensor 130 that is configured for detecting or measuring the level of at least one analyte within the fluid sample. The thickness of each test pad 220 is such that the test pad 220 can be disposed in contact with or adjacent or in very close or close proximity to the set of sensors 130, in accordance with the type(s) of sensor(s) 130 under consideration. Typically, each test pad 220 has a thickness that is significantly smaller or much smaller than its width and/or length. In a representative embodiment, each test pad 220 can have a thickness of 0.05-1.0 mm.

In various embodiments, the support layer 210 and thus the test pads 220 and cleanse pads 240 carried thereby can be controllably displaced along a forward/forward motion/indexing direction indicated by an arrow in FIGS. 2A-2C, within an along a first or primary internal passage or channel 180 internal to the housing 102. The primary channel 180 can include or be a passage formed from a plurality of internal surfaces (e.g., rigid surfaces, which can be formed from polymer/plastic materials) of the cartridge 100, for instance, such that the support layer 210 resides upon a bottom surface of the primary channel 180, and the test pads 220 and other pad elements, such as cleanse or cleanse capable pads 240, extend upward toward a top surface of the primary channel 180. The primary channel 180 exhibits a first or primary cross sectional area (e.g., formed by a plurality of surfaces or structures internal to the housing 102) perpendicular to the forward motion direction.

In association with such forward displacement of the support layer 210, each test pad's fluid sampling region 224 can be selectively positioned with respect to the port 105 of the cartridge 100. As a result, when a particular test pad 220 (e.g., a “ready for use” or “in use” test pad 2]20) is appropriately positioned relative to the port 105, its fluid sampling region 224 can protrude a predetermined distance beyond the port 105 into the cartridge's external environment for receiving a fluid sample, as indicated in FIG. 2B. While the fluid sampling region 224 of the ready for use/in use test pad 220 is exposed to the cartridge's external environment by way of the port 105, (a) other portions of this test pad 220 of which this fluid sampling region 224 is a part, (b) the support layer 210 underlying and behind/rearward of this test pad 220, and (c) fresh/unused cleanse pads 240 and test pads 220 disposed behind this ready for use/in use test pad 220 remain internal (e.g., entirely internal) to the cartridge 100.

In this type of embodiment, each test pad's fluid sampling region 224 is not held down or retained in position by the support layer's adhesive film. Rather, each test pad's fluid sampling region 224 is disposed above or upon an adhesive free or non-adhesive zone, site, element, member, material, or medium 216 formed on the support layer 210. The adhesive free zone 216 extends across at least the transverse extent or width of each test pad 220, and spans a predetermined fraction (e.g., approximately 10%-30%, or about 20%) of each test pad's overall length. The region of each test pad 220 that is held or retained in place by the support layer's adhesive film can be defined as an anchoring region 226 that extends away from the test pad's fluid sampling region 224 to the test pad's second end 228.

In some embodiments, the adhesive free zone 216 on which each test pad's fluid sampling region 224 resides can be formed by way of an intermediary material disposed on the support layer's upper side 212, at predetermined support layer locations corresponding to each test pad's fluid sampling region 224. A lower interface of the intermediary material is adhered to the support layer's upper side 212, but an upper interface of the intermediary material excludes or omits an adhesive film for retaining the fluid sampling region 224. In other embodiments, the adhesive free zone 216 can be formed by way of altering or eliminating (e.g., by chemical and/or optical treatment or means) the adhesive film on the support layer 210, across an area corresponding to each test pad's fluid sampling region 224, such that each test pad's fluid sampling region 224 rests directly upon, adjacent to, or above, but is not adhered to, the support layer 210.

In view of the foregoing, as the support layer 210 is controllably advanced in a forward motion direction, the fluid sampling region 224 of a test pad 220 approaching the port 105 can travel to and at least partially through or beyond the port 105, thereby forming a test pad “tongue,” “finger,” or “stub” which protrudes or extends outside of the cartridge 100, as indicated in FIG. 2B. During such forward displacement, the support layer 210 can travel (e.g., under tension) along or around one or more guiding structures or elements such as a groove, wheel, notch, corner, ledge, and/or edge 108 that is internal to the cartridge 100. Once the support layer 210 has been displaced a predetermined distance in the forward motion direction, the test pad's tongue (i.e., portions of its fluid sampling region 224) protrudes a predetermined distance into the external environment of the cartridge 100, and advancement of the support layer 210 in the forward motion direction can be interrupted or halted. One or more portions of the test pad's tongue can subsequently receive a fluid sample.

In a number of embodiments, in response to the receipt of a fluid sample, the test pad quickly transports or distributes the fluid sample throughout or substantially throughout the test pad's active area 230, or throughout/substantially throughout the entire test pad 220. In association with the transport of the fluid sample throughout the test pad 220, the fluid sample reacts with the reagent(s) carried by the test pad 220. Based upon such reaction(s), the sensor(s) 130 can perform a set of measurements to estimate or determine the level of one or more analytes within the fluid sample. The support layer 210 can subsequently be further advanced in the forward motion direction, causing the test pad's tongue to be automatically captured, retracted, or drawn back inside the cartridge 100.

As indicated in FIGS. 2A-2C, in various embodiments the support layer 210 carries cleanse pads 240 in addition to test pads 220, where each cleanse pad 240 includes or is a thin or very thin layer of typically flexible material having a thickness that is significantly smaller or much smaller than its width and/or length. Each cleanse pad 240 has a predetermined width relative to the support layer 210; and a predetermined length between a first end 242 and a second end 248 of the cleanse pad 240, along a small segment of the support layer's overall length. In multiple embodiments, each cleanse pad 240 is elongate, having a length that is greater than its width. In other embodiments, a cleanse pad 240 can have a length that is less than or equal to its width. Depending upon embodiment details, cleanse pads 240 can be longer than, the same length as, or shorter than test pads 220. In several embodiments, each cleanse pad 240 is at least as wide as the sensor or sensor-related surface(s) that may have been exposed to a fluid sample carried by a preceding test pad 220 (and may be wider than such surfaces), and/or at least as wide as the width of the support layer 210. In a representative embodiment, cleanse pads 240 can be 2-8 mm long, and 1-4 mm wide or wider. Each cleanse pad 240 is adhered to the support layer 210 at least substantially across the cleanse pad's width and length.

In multiple embodiments, any given cleanse pad 240 can clean or wipe one or more sensor and/or sensor related surfaces which were exposed or exposable to the fluid sample carried by a test pad 220 most recently under consideration, that is, the test pad 220 that immediately precedes or is disposed immediately ahead of or adjacent to the cleanse pad 240 with respect to the forward movement direction of the support layer 210 toward and past the port 105. More particularly, as the support layer 210 is advanced in the forward motion direction such that a used test pad 220 that carries a fluid sample is transitioned past and away from the sensor(s) 130 and the port 105, an fresh/unused cleanse pad 240 that has not yet been wiped across sensor surfaces (and hence has not yet been exposed to potential residual fluid sample that may be present on the set of sensors 130 and/or cartridge-internal surfaces that carry the set of sensors 130), and which directly follows this used test pad 220 on the support layer 210, is automatically displaced or drawn across the surface(s) of the sensor(s) 130 or cartridge-internal surfaces corresponding thereto. This cleanse pad 240 can therefore remove or wipe residual fluid sample off of the sensor(s) 130 and/or such cartridge-internal surfaces (e.g., a cartridge surface behind which a sensor 130 is disposed, such as an optical sensor 130 that is positioned behind a glass or plastic surface/window that is appropriately optically translucent, transmissive, or non-absorbing with respect to one or more optical wavelengths under consideration), prior to (a) the positioning of a next or new fresh test pad 220 with respect to the port 105 and the sensor(s) 130, (b) the receipt of a next or new fluid sample by such a test pad 220, and (c) corresponding fluid sample analyte measurement by way of the sensor(s) 130.

A cleanse pad 240 can be made of one or more types of materials, including a material that is identical or substantially identical to or different than the material(s) from which the test pads 220 are made. For instance, in some embodiments, each cleanse pad 240 includes or is a fibrous material; while in other embodiments, each cleanse pad includes or is a non-fibrous (e.g., foam-based/sponge-type) material. In general, the width of a cleanse pad 240 is at least as wide as, and in several embodiments at least slightly wider than, the width of a test pad 220. In some embodiments, cleanse pads 240 and test pads 220 have essentially identical thicknesses; while in other embodiments, cleanse pads 240 are slightly thicker than test pads 220. In general, the thickness of a cleanse pad 240 is such that at least a portion (e.g., a substantial portion) of the length of the cleanse pad 240 comes into contact with the set of sensors 130 and/or cartridge-internal surfaces corresponding thereto as the cleanse pad 240 is advanced in the forward test tape displacement direction and drawn across or against the set of sensors 130 and/or such surfaces. In a representative embodiment, cleanse pads 240 can be 0.1-1.1 mm thick.

In addition to the foregoing, a cleanse pad 240 can include or be formed from one or more types of materials capable of forming a fluid impermeable or essentially fluid impermeable barrier or seal (e.g., a hermetic seal) between the port 105 and portions of the primary channel 180 that are rearward of a set of sealing elements 106 when portions of the cleanse pad 240 are drawn across, abuts, or is positioned/parked against the set of sealing elements 106. The formation of such a fluid impermeable/hermetic seal isolates fresh/unused test pads 220 that are disposed along the support layer 210 rearward of the set of sealing elements 106 from the port 105. Cleanse pads 240 that are configured for both cleansing/wiping the set of sensors 130 as well as fluidically/hermetically isolating or sealing portions of the cartridge's internal environment from the cartridge's external environment can be referred to as cleanse and sealing pads (“cleanse-sealing pads”) 240. In a representative embodiment, a cleanse-sealing pad 240 includes or is a foam based or sponge-type material (e.g., a resilient foam material that is at least slightly deformable or compressible, such as a closed-cell foam material or an appropriate type of open-cell foam material) configured for forming a fluid impermeable or essentially fluid impermeable seal when the cleanse-sealing pad 240 is appropriately positioned relative to the set of sealing elements 106, as further described in detail hereafter.

As indicated in FIGS. 2B and 2C, multiple embodiments in accordance with the present disclosure include at least one set of sealing elements 106 disposed at a predetermined location relative to or along the primary channel 180, rearward of the port 105 and the set of sensors 130 (e.g., proximate to or directly behind the set of sensors 130). As indicated in FIG. 2D, some embodiments include multiple (e.g., 2 or more) sets of sealing elements 106a,b, where each set of sealing elements 106a,b is disposed at a predetermined location relative to or along the primary channel 180. Each set of sealing elements 106a,b can include one or more types of protrusions, ridges, indentations, and/or other structural sealing/barrier features carried or formed internal to cartridge's housing 102, which reduce, constrict, or partially obstruct the primary cross sectional area of the primary channel 180 to thereby form a secondary channel or channel segment 182a,b. Each secondary channel or channel segment 182a,b has a secondary channel length 184a,b, which exhibits a secondary cross sectional area perpendicular to the forward motion direction. The secondary cross sectional area of each secondary channel 182a,b is smaller than or fits within the primary cross sectional area of the primary channel 180. Different secondary channels 182a,b can have identical or different secondary channel lengths 184a.b, depending upon embodiment details. A set of sealing elements 106 includes smooth or low-friction surfaces to facilitate smooth displacement of cleanse-sealing pads 240 within the secondary cross sectional area provided by a secondary channel 182a,b.

FIG. 2E is a cross sectional illustration showing a representative secondary channel 182 enclosed or surrounded by a representative primary channel 180 in accordance with an embodiment of the present disclosure. The inner borders of the secondary channel 182, and hence the boundaries of the second cross sectional area, are defined by inner borders or boundaries of a set of sealing elements 106, as indicated in FIGS. 2B-2D. The support layer 110 as well as the test pads 220 and the cleanse-sealing pads 240 carried thereby are displaceable along the forward motion direction through each of the primary cross sectional area corresponding to the primary channel 180 and the secondary cross sectional area corresponding to each secondary channel 182. In various embodiments, each test pad 220 has a cross sectional area perpendicular to the forward motion direction that is less than or equal to the secondary cross sectional area of each secondary channel 182, and possibly a width that is less than the width of the support layer 210.

FIG. 2F illustrates a representative cross sectional area of a test pad 220 relative to the secondary cross sectional area of the secondary channel 182 in accordance with an embodiment of the present disclosure. Each cleanse-sealing pad 240, however, has a cross sectional area that is equal to or slightly larger than (e.g., 2%-10%, or 2.5%-5% greater than) the secondary cross sectional area of each secondary channel 182, minus the cross sectional area of the support layer 210, for purpose of establishing a fluid impermeable seal within the secondary channel 182. More particularly, when portions of a given cleanse-sealing pad 240 reside within a secondary channel 182 and are thus disposed against a set of sealing elements 106, such portions of the cleanse-sealing pad 240 fill the secondary cross sectional area of the secondary channel 182 that are not occupied by the cross sectional area of the support layer 210.

For instance, FIG. 2G is a cross sectional illustration in accordance with an embodiment of the present disclosure showing a representative manner in which a cleanse-sealing pad 240 occupies or fills those portions of a secondary channel 182 that are not occupied by the support layer 210 when portions of the cleanse-sealing pad 240 are disposed therein. As indicated in FIG. 2G, areas within the secondary channel 182 that are not occupied by the cross sectional area of the support layer 210 are completely filled in or occupied by the cleanse-sealing pad 240. Given that the width of the support layer 210 is generally at least slightly less than the width of the secondary channel 182, the cross sectional extent of the cleanse-sealing pad 240 can extend beyond the width of the support layer 210, and downward below the support layer's upper side 212 toward and to a bottom surface of the secondary channel 182 on which the support layer's lower side 214 resides to facilitate or enable the formation of a hermetic seal within the secondary channel 182.

In various embodiments, when a portions of a given cleanse-sealing pad 240 reside within the secondary channel 182, inner borders or surfaces of the set of sealing elements 106 exert at least a slight inward compressive force against the cleanse-sealing pad's outer or peripheral surfaces. Correspondingly, the outer surfaces of this cleanse-sealing pad 240 that are disposed against the inner surfaces of the set of sealing elements 106 exert a resilient outward expansive force thereupon. The inward compressive force exerted by the set of sealing elements 106 upon outer surfaces of the cleanse-sealing pad 240 that are disposed against the set of sealing elements 106 can additionally slightly press the support layer 210 beneath the cleanse-sealing pad 240 downward against the bottom surface of the secondary channel 182. As a result of the aforementioned forces, those portions of the cleanse-sealing pad 240 that abut the set of sealing elements 106 and other portions of the cleanse-sealing pad 240 that extend across the secondary channel's cross sectional area form a hermetic seal that prevents or effectively prevents moisture that may be present within the primary channel 180 forward of the cleanse-sealing pad 240 from traveling rearward beyond the set of sealing elements 106 to fresh/unused test pads 220 behind the cleanse-sealing pad 240. In some embodiments, frontal borders or edges each cleanse-sealing pad 240 are chamfered or slightly tapered inward, toward a central portion of the cleanse-sealing pad 240, in order to facilitate smooth entry of the cleanse-sealing pad 240 into the secondary cross sectional area provided by the secondary channel 182.

In view of the foregoing, as a result of the cleanse-sealing pad's filling of the secondary channel's secondary cross sectional area when the cleanse-sealing pad 240 is advanced along and interfaces with the set of sealing elements 106, a fluid impermeable barrier or seal is established across the secondary channel 182 and around the periphery thereof, which fluidically/hermetically isolates fresh/unused test pads 220 disposed rearward of this cleanse-sealing pad 240 from the environment forward of this cleanse-sealing pad 240, for instance, in a manner indicated in FIGS. 2B-2D. Further in view of the foregoing, hermetic sealing of fresh/unused test pads 220 from sources of moisture, humidity, and/or other types of contamination in accordance with embodiments of the present disclosure requires no additional actuation elements or devices, such as mechanical/spring based or other types of actuated sealing mechanisms, than would be required for ordinary advancement of the test medium 200 along the forward motion direction. Embodiments in accordance with the present disclosure thus provide a simple, low cost, and reliable manner of hermetically sealing fresh/unused test pads 220 within the cartridge 100 from actual and potential environmental contaminants, thereby maintaining the long term stability of the fresh/unused test pads 220.

In some embodiments such as that shown in FIG. 2C, cleanse-sealing pads 240 are at least somewhat or substantially/significantly longer that test pads 220, for instance, 1.25-2.75 (e.g., 1.5, 2.0, or 2.5) times longer than test pads 220. In this and other embodiments, after a given ready for use/in use test pad 220 has been used (i.e., is no longer fresh), an immediately subsequent cleanse-sealing pad 240 can be displaced in the forward motion direction to wipe the set of sensors 130 and/or internal cartridge surfaces associated therewith, and further advanced a predetermined distance in the forward motion direction along a portion of the cleanse pad's length to a “parked” position. Once the cleanse-sealing pad 240 is disposed at the parked position, the sensor(s) 130 and/or surfaces associated therewith have been wiped or cleaned, and portions of this cleanse-sealing pad 240 remain in contact with one or more sealing structures 106 (e.g., which can be formed from or as particular portions of the cartridge 100, such as a set of inner surfaces of the housing 102) in order to hermetically isolate fresh test pads 220 behind this parked cleanse-sealing pad 240 from the port 105. When a next fresh test pad 220 is to be advanced to or aligned with the port 220, the parked cleanse-sealing pad 240 can be displaced a predetermined distance along the forward motion direction, until this cleanse-sealing pad 240 has advanced past the port 105 and a next ready for use test pad's fluid sampling region 224 projects into or through the port 105.

In some embodiments, the test tape 200 includes not only test pads 220 and cleanse pads 240, but also other distinct or dedicated pads separate from the test pads 220 and the cleanse pads 240 that facilitate or enable the formation of a hermetic seal that isolates fresh/unused test pads 220 from an external environment to which the cartridge 100 is exposed or exposable. FIG. 2H illustrates a representative embodiment in accordance with the present disclosure, in which test pads 220, cleanse pads 240, and sealing pads 260 are arranged along the test tape 200 as a succession of test pad 220-cleanse pad 240-sealing pad 260 triplets. Thus, along a length of the test tape 200 from a forward to rearward direction, a test pad 220 is directly followed by a cleanse pad 240, which is directly followed by a sealing pad 260, which is directly followed by a test pad 220, and so on. Each sealing pad 260 can include one or more types of resilient materials that are at least slightly compressible/deformable, such as a foam type or sponge based material. Each sealing pad 260 has a cross sectional area that is at least as large as or slightly larger than (e.g., by about 2%-10%, or about 2.5%-5%) the secondary cross sectional area of each secondary channel 182. An individual having ordinary skill in the relevant art will understand that the description herein relating to the formation of a hermetic seal within the secondary channel 182 by way of a cleanse-sealing pad 240 applies analogously or equivalently to dedicated sealing pads 260. Thus, in a manner analogous or essentially identical to that described above, when portions of a sealing pad 260 are displaced along or parked against and interface with a set of sealing elements 106, such portions of the sealing pad 260 fill the secondary cross sectional area of a secondary channel 182 and establish a hermetic seal therein, which prevents moisture that may be present within the primary channel 180 forward of the sealing pad 260 from traveling rearward beyond this hermetic seal and reaching fresh/unused test pads 220 behind or rearward of the sealing pad 260.

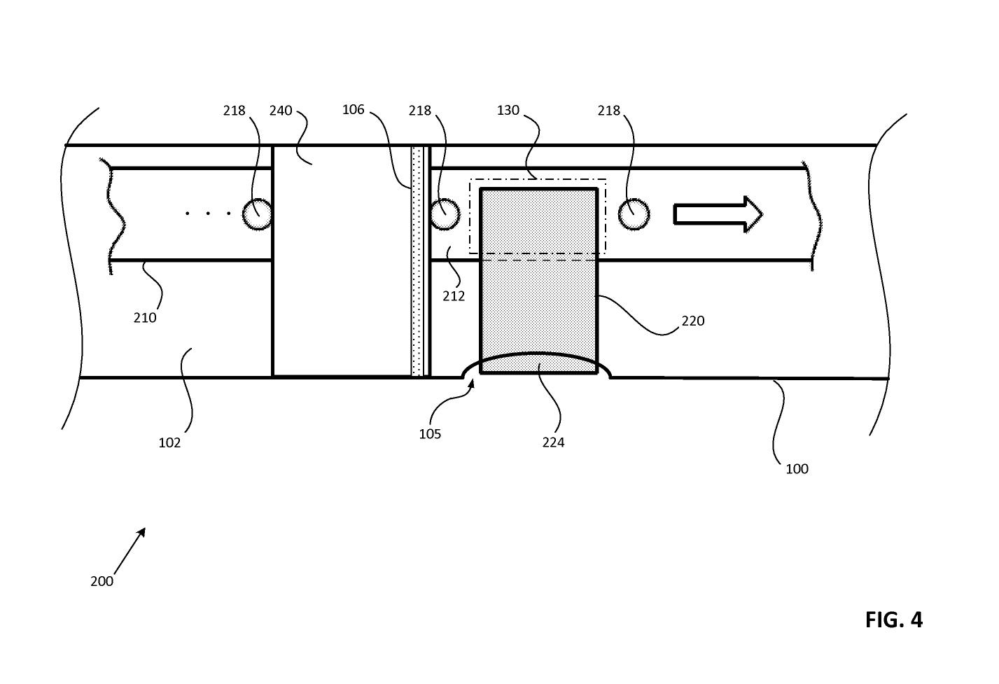

An individual having ordinary skill in the art will also recognize in view of the above description that essentially any embodiment of a continuous medium in accordance with the present disclosure that carries test pads 220 and cleanse-sealing pads 240, such as embodiments described below with reference to FIGS. 4-10, can alternatively carry test pads 220, cleanse pads 240, and distinct sealing pads 260. Some of such embodiments can alternatively carry test pads 220 and sealing pads 260, but omit cleanse pads 240.

In addition or as an alternative to the foregoing, in a number of embodiments particular portions of the test tape 200 itself include or carry other isolation features that facilitate the formation of a hermetic seal by which fresh test pads 220 are isolated from the port 105 and the cartridge's external environment. As further described below, in addition or as an alternative to one or more portions of cleanse-sealing pads 240 and/or dedicated sealing pads 260 forming such environmental isolation features, one or more other types of structural elements carried by the test tape 200 can serve as environmental isolation zones or elements.

As indicated above, (a) each test pad 220, (b) each cleanse pad 240 or cleanse-sealing pad 240, and in embodiments that include distinct sealing pads 260, (c) each sealing pad 260 disposed along the support layer 210 is displaceable in the forward motion direction relative to the (i) port 105, (ii) each set of sealing element(s) 106, and (iii) the set of sensors 130 by way of controlled/indexed displacement of the support layer 210. In some embodiments, the support layer 210 includes displacement control or indexing structures, for instance, openings 218 such as sprocket holes therein, which facilitate or enable controlled or indexed displacement of the support layer 210 (e.g., along the forward motion direction). Such openings 218 can reside along a midline of the support layer 210, and/or along support layer edges. Depending upon embodiment details, controlled displacement of the support layer 210 and the pad elements 220, 240, 260 carried thereby can occur by way of manual, semi-automatic, or automatic (e.g., actuator/motor driven) mechanisms or elements. Such mechanisms or elements can reside in the cartridge 100, and/or the body 52 of an analyte measurement instrument 50.

Aspects of a Representative Test Tape Cartridge Embodiment

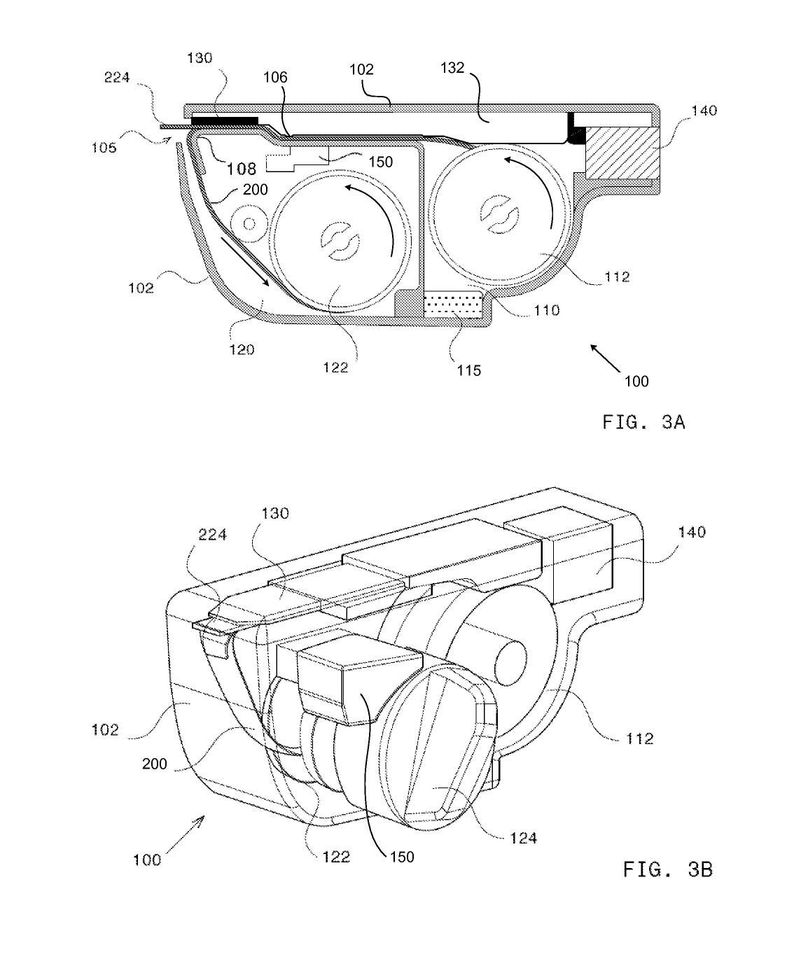

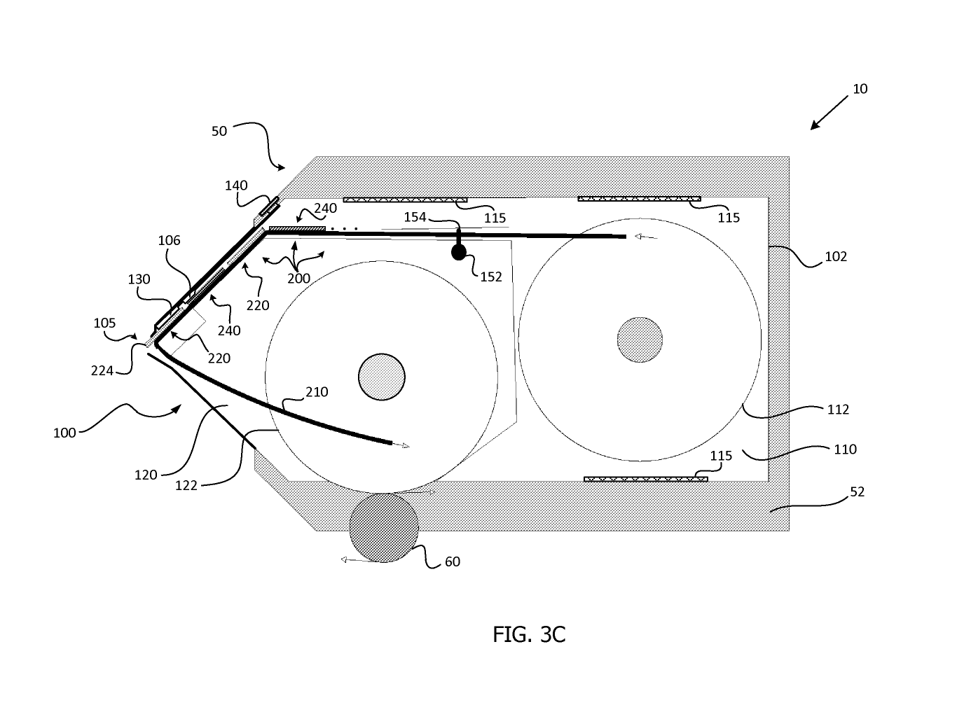

FIG. 3A is a cross sectional illustration of a representative cartridge 100 according to an embodiment of the present disclosure, and FIG. 3B is a perspective view of the cartridge 100 of FIG. 3A. The cartridge 100 is configured for removable or replaceable mating engagement with an analyte monitoring, metering, or measurement device 50 such as that shown in FIG. 1, in a manner readily understood by one having ordinary skill in the relevant art. The cartridge 100 is further configured for carrying and enabling controlled, selectable/selective displacement of a test tape 200 such as that described above with reference to FIGS. 2A-2G to facilitate the measurement of one or more types of analytes within fluid samples received by test pads 220. For purpose of simplicity and to aid understanding, with respect to the following description directed to FIGS. 3A-3B, the test tape 200 includes test pads 220 and cleanse-sealing pads 240. However, one having ordinary skill in the art will readily understand that that such description analogously or essentially identically applies to test tapes 200 that include distinct sealing pads 260 (e.g., rather than cleanse-sealing pads 240), as well as test tapes 200 that include test pads 220 but which omit cleanse pads 240, cleanse-sealing pads 240, and/or sealing pads 260.

In various embodiments, the cartridge 100 includes a housing 102 having a first or source compartment or chamber 110 from which fresh test pads 220 and fresh cleanse-sealing pads 240 are sourced or obtainable/providable; and a second or destination compartment or chamber 120 into which used test pads 220 and used cleanse-sealing pads 240 are directed or transferrable. In an embodiment, a source spool 112 resides in the source compartment 110, and a destination spool 122 resides in the destination compartment 120. The test tape's support layer 210 is disposed around or about each of the source spool 112 and the destination spool 114, and extends therebetween. More particularly, the source spool 112 carries those portions of the test tape's support layer 210 on which fresh test pads 220 and fresh cleanse-sealing pads 240 reside; and the destination spool 122 carries portions of the test tape's support layer 210 on which used test pads 220 and used cleanse-sealing pads 240 reside. Thus, those portions of the support layer 210 carrying fresh test pads 220 and fresh cleanse-sealing pads 240 are concentrically wound around the source spool 112; and portions of the support layer carrying used test pads 220 and used cleanse-sealing pads 240 are concentrically wound around the destination spool 122. Within the cartridge 100, each of the source and destination spools 112, 122 can be supported by a rod, shaft, axle, spindle, roller, or pin about which the spool 112, 122 is rotatable, in a manner readily understood by one having ordinary skill in the relevant art.

The cartridge 100 further includes, can mate with, and/or can be driven by a set of test tape advancement or drive mechanisms or elements 124 and test tape indexing mechanisms or elements 150 that can be manually, semi-automatically, or automatically activated. The test tape advancement elements 124 and indexing elements 150 are configured for controllably advancing or indexing the test tape 200 along a forward motion direction (indicated by arrows in FIGS. 3A and 3B), such that (a) fresh test pads 220 and fresh cleanse-sealing pads 240 can be controllably and selectively/selectably transferred from the source compartment 110 toward and to the set of sensors 130, and test pads 220 can be positioned relative to the port 105 for receiving fluid samples; and (b) used test pads 220 and used cleanse-sealing pads 240 can be controllably transferred away from the set of sensors 130 and the port 105 to the destination compartment 120. In an embodiment such as that shown in FIGS. 3A and 3B, the set of test tape advancement elements 124 is configured for controllably rotating at least the destination spool 122 relative to or along the forward motion direction, such that the test pads 220 and cleanse-sealing pads 240 can be drawn from the source compartment 110 toward the destination spool 122; test pads 220 and cleanse-sealing pads 240 can be controllably and selectively positioned relative to (e.g., at/under/adjacent to) the set of sensors 130; and each test pad's fluid sampling region 224 can be positioned to extend through the port 105 into the cartridge's external environment. Depending upon embodiment details, the set of test tape advancement elements 124 can include a knob, a gear, a wheel, a shaft, a ratchet, and/or another type of mechanical structure configured for manually, semi-automatically, or automatically advancing the test tape 200 in the forward motion direction in a controlled/controllable/indexed/indexable/stepwise manner.

In a number of embodiments, the set of test tape indexing elements 150 includes one or more teeth or pins that can releasably or retractably engage with the test tape's sprocket holes 218. In some embodiments, the cartridge 100 also includes one or more guiding and/or tension regulation elements configured for respectively guiding the test tape and/or maintaining the tension of the test tape along its travel path between the source compartment 110/source spool 112 and the destination spool 122.

The cartridge 100 is configured for providing controlled or substantially constant/predictable environmental conditions within the source compartment 110, such that fresh test pads 220 within the source compartment 110 remain unexposed, essentially unexposed, or substantially unexposed to moisture, condensation, and uncontrolled/variable humidity conditions. As indicated above, in various embodiments, the cartridge 100 internally carries sealing or isolation features or structures, such as one or more sets of sealing elements 106, configured for hermetically sealing the source compartment 110 from the cartridge's external environment. In the embodiment shown in FIGS. 3A and 3B, such sealing/isolation features can include cleanse-sealing pads 240 or sealing pads 260, as well as a number of sealing protrusions 106 (e.g., a single protrusion or an array of protrusions 106) internal to the cartridge 100, in a manner essentially identical or analogous to that described above. Depending upon embodiment details, one or more of such protrusions 106 can be formed in the housing 102 of the cartridge 100, or carried by or formed in a sensor module 132 that carries the set of sensors 130. A protrusion 106 can include a smooth or low-friction surface to facilitate smooth displacement of test pads 220 and cleanse pads 240 thereacross. The source compartment 110 can additionally carry a desiccant 115 within one or more portions thereof (e.g., spray-applied onto internally exposed source compartment walls, and/or positioned or secured in packet form in a source compartment recess, cavity, or slot) for absorbing moisture and maintaining a moisture-controlled environment within the source compartment 110.

Additionally, in some embodiments, the cartridge 100 includes a cap (not shown) that is configured for selectively/selectably covering the port 105, which can be removed from the cartridge 100 when a fluid sample is to be provided to a test pad 220. The cap can include seal elements (e.g., gasket elements) that facilitate hermetic sealing of portions of the cartridge's internal environment from its external environment.

As indicated above, in several embodiments, the set of sensors 130 is carried by the cartridge 100 (e.g., internal to the cartridge's housing 102). In multiple embodiments, the set of sensors 130 forms portions of a sensing or sensor module 132, which includes sensing elements themselves (e.g., electrodes, LEDs, and/or photodetectors), associated sensing signal transfer elements (e.g., electrical wiring), possibly sensing signal conditioning elements (e.g., signal filters), and/or other elements. The sensor module 132 can be configured to interface with a signal communication interface 140 carried by the cartridge 100, such as a multi-pin (e.g., 4 pin) electrical interface that can mate with a corresponding interface of the analyte measurement device 50.

In a number of embodiments, the cartridge 100 and/or the analyte measurement device 50 include a set of mating engagement, locking, latching, or retaining elements or structures that facilitate simple, rapid, and secure engagement of the cartridge 100 with the analyte measurement device 50, as well as simple, rapid disengagement of the cartridge 100 therefrom. The mating engagement elements can facilitate correct insertion of cartridges 100 into the analyte measurement device 50, such that consistent or reliable analyte measurements can be made after each cartridge replacement event (for instance, when a given cartridge 100 is removed because each test pad 220 residing on the cartridge's test tape 200 has been used and no more fresh test pads 220 are available, and a new cartridge 100 is inserted into the analyte measurement device 50 such that further analyte measurements can be performed).

FIG. 3C is a schematic illustration of a representative cartridge 100 mounted within a representative analyte measurement device 50 in accordance with an embodiment of the present disclosure, in which the analyte measurement device 50 carries a set of active, main, or primary drive devices or elements that when activated cause advancement of the test tape 200 in the forward motion direction, for instance, in accordance with an indexed displacement distance. In such an embodiment, the cartridge 100 includes a number of passive or secondary drive elements that are themselves driven, activated, or engaged by the active drive elements carried by the analyte measurement device 50 to facilitate test tape advancement in the forward motion direction.

For instance, in an embodiment the analyte measurement device 50 includes a drive wheel and/or gear 60, which engages with the destination spool 122 when the cartridge 100 is mated with or inserted into the body 52 of the analyte measurement device 50. In several embodiments, the wheel 60 is automatically driven by an actuator/motor carried by the analyte measurement device 50; however, in some embodiments, the wheel 60 can alternatively or additionally be manually driven. When the wheel 60 is rotated in a predetermined direction (e.g., clockwise), the wheel's engagement with the destination spool 122 causes the destination spool 122 to rotate in an opposite direction (e.g., counterclockwise), which pulls the test tape 200 in the forward motion direction such that test pads 220 and cleanse-sealing pads 240 carried by the test tape 220 are drawn toward the destination chamber 120.

At least one indexing pin or indexing pin structure 152 can be carried within the cartridge 100. Prior to a test tape advancement sequence involving rotation of the wheel 60 and hence rotation of the destination spool 122. The indexing pin structure 152 is located a predetermined integral number of indexing units away from a ready to use test pad 220 or a cleanse-sealing pad 240 disposed at the port 105. The indexing pin structure 152 includes a projection 154 that engages with the test tape 200 by perpendicularly passing through an indexing hole 118 of the test tape 200. The indexing pin structure 152 can include or be made of a magnetic material, such that it can be driven or slidably advanced in the forward motion direction by way of one or more magnets carried by the analyte measurement device 50. The wheel 60 and the magnet(s) carried by the analyte measurement device 50 can be cooperatively activated or driven to advance the test tape 200 by a predetermined indexing distance in the forward motion direction, for instance, such that test pads 220 and cleanse-sealing pads 240 are disposed and parked at the port 105 in an intended or predetermined sequence or manner (e.g., an alternating manner; or such that ready to use test pads 220 are disposed and parked at the port 105 in direct succession).

An embodiment such as that shown in FIG. 3C can result in a simpler and less costly cartridge 100, because the cartridge 100 need not carry active mechanical drive devices or elements (e.g., one or more actuators/motors). Rather, the cartridge 100 includes passive drive elements that are themselves driven by active drive devices/elements of the analyte measurement device 50. In a number of embodiments, the cartridge 100 also includes a test tape tensioning spring to facilitate constant tension on portions of the test tape 200 (e.g., the support layer 210), and thus reliable indexed displacement along the forward motion direction.

Aspects of Other/Alternate Representative Continuous Media

A wide variety of continuous medium configurations exist in accordance with embodiments of the present disclosure. For instance, one having ordinary skill in the relevant art will recognize that in an alternate embodiment, the test tape 200 can reside in the source compartment 110 in the form of a test tape roll, without the presence of the source spool 112. The test tape 200 can be advanced along the forward motion direction by way of a pulling force communicated thereto or therealong (e.g., by way of rotational displacement of the destination spool 122). As another alternate embodiment, the test tape 200 can be stored in the source compartment 110 in a folded or “accordion type” configuration, such that test pads 220 can be drawn from the source compartment 110 by way of progressive unfolding of the test tape 200.

Furthermore, in some embodiments, an end section of the test tape 200 includes (a) multiple cleanse or cleanse-sealing pads 240 disposed along the support layer 210 in direct succession to each other, with no intervening test pads 220 disposed therebetween; and/or (b) one or more extended length cleanse or cleanse-sealing pads 240. Such multiple and/or longer cleanse/cleanse-sealing pads 240 along the test tape's end section can facilitate more complete cleansing of the cartridge's port region prior to cartridge replacement.

Additionally or alternatively, in specific embodiments, a test tape 200 can include fluid sampling pads that are fluidically coupled to distinct analyte measurement pads, rather than test pads 220 having an integrated or integral structure. For a given fluid sampling pad-analyte measurement pad pair, such fluid coupling can be achieved by way of abutment of the fluid sampling pad and the analyte measurement pad; or a fluid communication bridge (e.g., which includes a set of fluid transport fibers) therebetween. Each fluid sampling pad-analyte measurement pad pair along the test tape 200 is separated by a cleanse pad 240, cleanse-sealing pad 240, or sealing pad 260, in a manner analogous to that described for other embodiments herein.

Aspects of particular non-limiting alternative configurations of continuous media are described in detail hereafter. For purpose of simplicity and to aid understanding, such alternative continuous medium configurations are primarily shown and described as including test pads 220 and cleanse-sealing pads 240. However, one having ordinary skill in the relevant art will understand based upon the description herein that essentially any alternative continuous medium configuration can include test pads 220, cleanse pads 240, and distinct sealing pads 260; and certain alternative continuous medium configurations that rely upon all-optical sensing can include test pads 220 and distinct sealing pads 260, but can omit cleanse pads 240.

FIG. 4 illustrates portions of a particular embodiment of a test tape 200 disposed within portions of a cartridge 100 in accordance with the present disclosure. The test tape 200 of FIG. 4 is structurally and functionally analogous to those described above with reference to FIGS. 2A-2H, except that the test pads 220 and cleanse-sealing pads 240 are disposed on the test tape 200 such that each test pad's length and each cleanse-sealing pad's length is transverse or perpendicular to the elongate length of the test tape 200. A top side or a bottom side of the cartridge's housing 102 can have a port 105 formed therein, relative to which a fluid sampling region 224 of each test pad is controllably and selectively/selectably positionable such that the fluid sampling region 224 can be aligned with the port 105 and exposed to the cartridge's external environment, in a manner analogous to that previously described. The set of sensors 130 is disposed in alignment with the test tape's support layer 210 (e.g., above or beneath the support layer 210, with reference to the top side and bottom side of the cartridge 100), such that once a given test pad 220 is positioned with its fluid sampling region 224 in alignment with the port 105, and a fluid sample is received thereby and transported throughout the test pad's active area, (a) the set of sensors 130 can measure the level of an analyte within the test pad's active area, and (b) a cleanse-sealing pad 240 positioned directly behind this test pad 220 can subsequently be advanced in the forward motion direction and drawn across the set of sensors 130 and/or cartridge-internal surfaces corresponding thereto.

As also illustrated in FIG. 4, the cleanse-sealing pads 240 are also disposed transverse or perpendicular to the elongate length of the test tape 200. Each cleanse-sealing pad 240 extends across an internal width of the cartridge 100 corresponding to an internal cross sectional area of the cartridge 100 through which a fluid could flow toward fresh/unused test pads 220 disposed rearward of the cleanse-sealing pad 240. A set of structural sealing elements 106 extends across this internal width of the cartridge 100, such that when a cleanse-sealing pad 240 is drawn in the forward motion direction across the sealing element(s) 106, portions of the cleanse-sealing pad 240 are compressed beneath the sealing element(s) 106 to form a hermetic seal that fluidically/hermetically isolates fresh/unused test pads 220 disposed rearward of the cleanse-sealing pad 240 that is engaged with the set of sealing elements 106 from an environment forward of this cleanse-sealing pad 240.

In an analogous or essentially identical manner, in embodiments in which dedicated sealing pads 260 are used for hermetically isolating fresh test pads 220 from the cartridge's external environment, the sealing pads 260 are disposed transverse or perpendicular to the elongate length of the test tape 200, and extend across an internal width of the cartridge 100 corresponding to the internal cross sectional area of the cartridge 100 through which a fluid could flow toward fresh/unused test pads 220. In such embodiments, cleanse pads 240 need not have the same dimensions and/or orientation as test pads 220 and sealing pads 260 (e.g., cleanse pads can be oriented such that the length of each cleanse pad 240 is along and parallel to the length of the test tape 200).

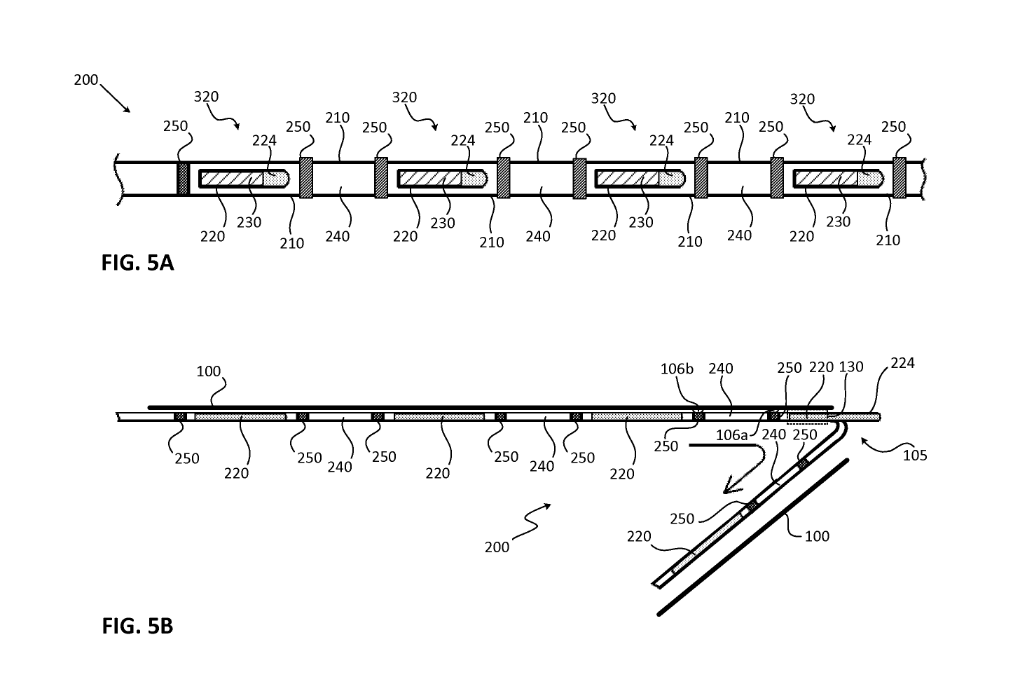

FIGS. 5A and 5B are schematic illustrations of a continuous medium in the form of a test tape 200 carrying test pads 220 and cleanse pads 240 in accordance with another embodiment of the present disclosure. In an embodiment, the test tape 200 includes or is an elongate piece or strip of material such as an elongate support layer, member, or material 210, from or on which each test pad 220 is integrally formed. In several embodiments, such a test tape 200 is formed from a continuous length of a single material 210 (e.g., a fluid transport material), which is segmented, segregated, or divided into spatially alternating types of distinct or distinguishable segments. In an embodiment, such spatially alternating types of segments include (a) test pad zones 320; (b) separation/sealing members or elements 250; and (c) cleanse pads 240. Any given test pad zone 320 is followed by a separation/sealing member 250, which is followed by a cleanse pad 240, which is followed by a test pad zone 320, and so on along the length of the test tape 200.

Each test pad zone 320 includes or encompasses an area of the support material 210 having a test pad 220 formed therein/thereon from the underlying support material 210 itself In an embodiment such as that shown in FIGS. 5A and 5B, the support material 210 itself can thus include or be at least one type of fluid transport material that can rapidly and uniformly distribute a fluid sample therein/therethrough. In the embodiment shown in FIGS. 5A and 5B, each test pad 220 is formed within a corresponding test pad zone 320 by way of (a) incorporation of a set of reagents into a particular portion or area of the test pad zone 320, to thereby form or define a test pad active area within the test pad zone 320; and (b) separation of particular portions of the underlying support material 210 within the test pad zone 320 which (a) form the active area, or (b) which can communicate a fluid sample into the active area, from other portions of the surrounding/adjacent support material 210 within the test pad zone 320. Such separation results in the formation of a test pad segment that is separate or separable from the adjacent support material 210. Each test pad segment can be created by way of cuts (e.g., mechanical and/or laser cuts) in the support material 210 within its corresponding test pad zone 320, such that the test pad segment is detached/physically separated (e.g., along 3 sides) from the surrounding/adjacent portions of the support material 310 within the test pad zone 320.

The physically detached or separated test pad segment includes a fluid sampling region 224 that can project into or through a port 105 of a cartridge 100 that carries the support material 210 when the test pad 220 is aligned with the port 105. That is, the physically separated test pad segment forms a test pad tongue or finger that is exposable to the cartridge's external environment by way of the port 105, at which the test pad 220 can receive a fluid sample that will be rapidly and uniformly distributed throughout the test pad's active area. The test pad segment and the adjacent support member 210 are isolated from each other with respect to fluid communication therebetween. That is, the mechanical or physical separation or detachment (e.g., by way of mechanical or laser cuts) between the test pad segment and the adjacent support member 210 is such that no or essentially no fluid is permitted to flow into the adjacent support member 210.

Each cleanse pad 240 is also integrally formed from a portion of the support material 210 (e.g., a fluid transport material). More particularly, each cleanse pad 240 can simply be a predetermined length and width of support material 210, at a predetermined position or location along the support material's elongate length. Advancement of a cleanse pad 240 along and past a set of sensors 130 and/or surfaces corresponding thereto can wipe portions of a fluid sample from the sensors 130 and/or such surfaces, in a manner analogous to that described above.

Any given separation/sealing member 250 is disposed between a test pad zone 320 and a cleanse pad 240, and is configured to provide (a) a fluid nontransporting/hydrophobic barrier across or through which fluid transport between its adjacent test pad zone 320 and its adjacent cleanse pad 240 is prevented or will not occur; and (b) a hermetic seal that isolates fresh test pads 220 from the cartridge's external environment when the separation/sealing member 250 is compressed against or beneath a set of structural isolation elements 106 carried by the cartridge 100. The fluid nontransporting/hydrophobic barrier can be formed by modifying the fluid transport properties of the support layer 210 across the position or location of each separation/sealing member 250, for instance, by way of thermal and/or chemical treatment. A separation/sealing member 250 can be thermally or otherwise treated/modified about its peripheral surfaces, and/or can carry a foam based or sponge-like material about its peripheral surfaces to facilitate the formation of a hermetic seal when engaged with a set of sealing elements 106, such that fresh/unused test pads 220 disposed rearward of the separation/sealing member 250 are fluidically/hermetically isolated from an environment forward of the separation/sealing member 250.

A set of sensors 130 is disposed relative to the port 105 such that when any given test pad 220 is aligned with the port 105 for receiving a fluid sample by way of its fluid sampling region 224, the set of sensors is also aligned relative to the test pad's active area for measuring the level of an analyte within the active area. The test tape 200 is controllably displaceable or indexable in a forward motion direction, in a manner analogous to that described above, such that test pads 220 and cleanse pads 240 can be positioned or aligned relative to the port 105 and the set of sensors 130.

In an alternate embodiment, the cleanse pads 240 are cleanse-sealing pads 240, which are formed along a predetermined section of the support material 210 as described above, and which are thermally or otherwise treated/modified and/or which carry a foam based or sponge-type material about their peripheral surfaces to facilitate the formation of a hermetic seal when engaged with a set of sealing elements 106 carried by the cartridge 100. In such an embodiment, the separation members 250 need not provide hermetic sealing functionality, although certain embodiments can include both cleanse-sealing pads 240 and separation/sealing members 250 for purpose of hermetically isolating fresh/unused test pads 220 from the cartridge's external environment. Still further embodiments can include dedicated sealing pads 260 in a manner analogous to that described above, where each sealing pad 260 is formed along a predetermined section of the support material 210, and is thermally or otherwise treated/modified and/or which carries a foam based or sponge-type material about its peripheral surfaces to facilitate the formation of a hermetic seal when engaged with a set of sealing elements 106 within the cartridge 100. Thus, in view of the foregoing, one or more portions of the test tape 200 can carry sealing features configured for hermetically sealing or isolating fresh test pads 220 from the cartridge's external environment.

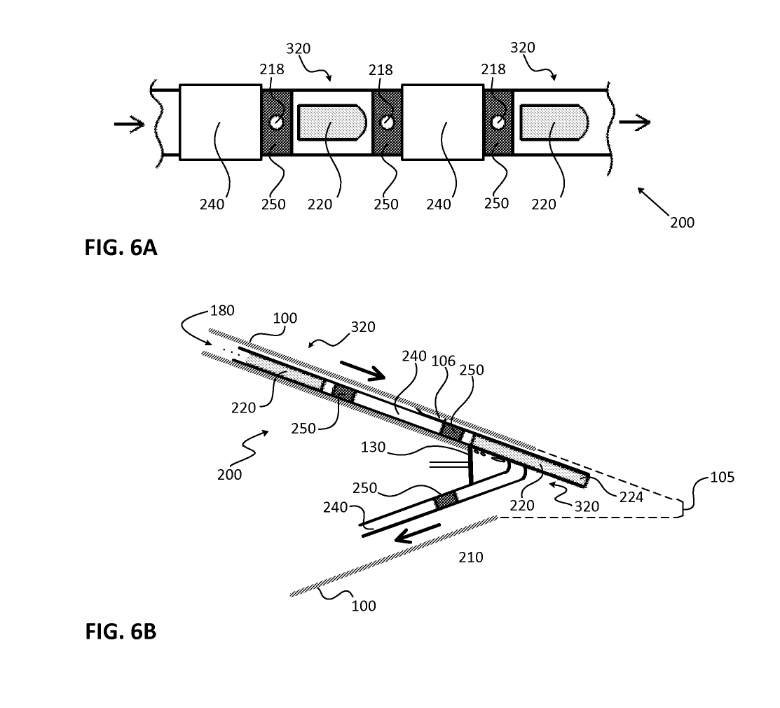

FIGS. 6A and 6B are schematic illustrations of a continuous medium corresponding or analogous to that shown in FIGS. 5A and 5B, and a representative alternate positioning of a set of sensors 130 relative thereto in accordance with an embodiment of the present disclosure. For purpose of illustration, in the embodiment of FIG. 6A and 6B the test tape 200 includes test pads 220, cleanse/sealing members 240, and separation members 250, where each cleanse/sealing member 240 is configured for providing a hermetic seal that fluidically/hermetically isolates fresh/unused test pads 220 rearward of the cleanse/sealing member 240 from an environment forward of the cleanse/sealing member 240 when the cleanse/sealing member 240 is engaged with a set of sealing elements 106 of the cartridge 100.

As indicated in FIG. 6A, the test tape 200 can include openings 218 such as indexing or sprocket holes therein, to facilitate controlled test tape indexing along a forward test tape displacement direction (which is once again indicated by arrows). As indicated in FIG. 6B, in an embodiment, the set of sensors 130 is positioned relative to a port 105 provided by the cartridge 100 such that a first or outer surface of each test pad 220 can receive a fluid sample at a fluid sampling region 224 by way of the port 105; and a second or inner surface of the test tape 200 wraps or folds around and is retained against or adjacent to the set of sensors 130.

In such an embodiment, the set of sensors 130 itself serves as a guiding structure that can maintain the orientation of the test tape 200 in an intended manner as it is displaced along the forward motion direction. As will be understood by one having ordinary skill in the relevant art, the test tape 200 can be maintained under tension by mechanical elements within the cartridge 100 and/or associated with internal compartments 110, 120 of the cartridge 100, such as a tensioning spring 160 and/or one or more spools 112, 122 described above, to facilitate consistent or reliable travel of a test tape inner surface around/against the set of sensors 130.

In an embodiment such as that shown in FIG. 6B, once a given test pad 220 receives a fluid sample, the fluid sample is transported along portions of the test pad's length and width as well as throughout the test pad's thickness, such that the test pad's active area and hence the analyte-bearing fluid sample carried by the test pad 220 is directly in contact with or directly adjacent or proximate to the set of sensors 130, in accordance with the type(s) of sensors 130 under consideration and the manner(s) in which the sensor(s) measure analyte levels.

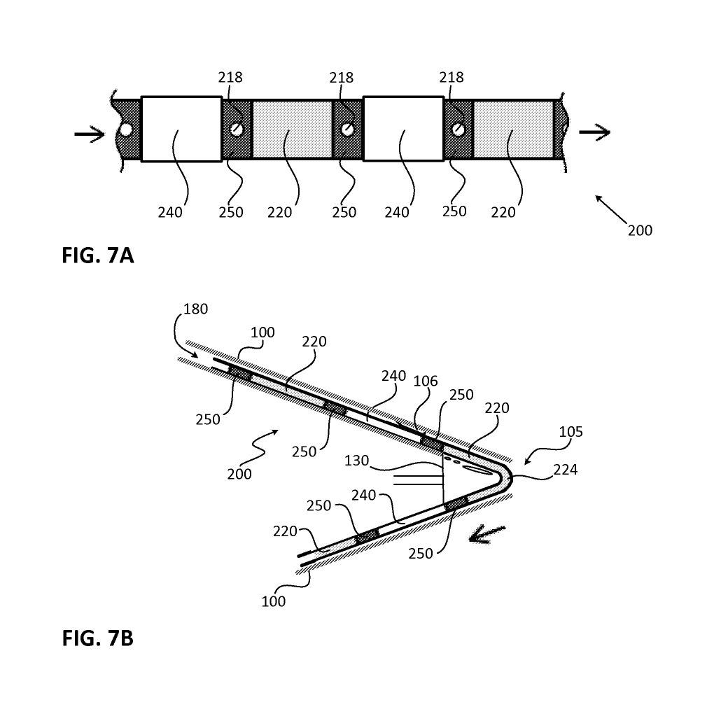

FIGS. 7A and 7B are schematic illustrations of a continuous medium in the form of a test tape 200 carrying test pads 220, cleanse-sealing pads 240, and separation members 250 in accordance with yet another embodiment of the present disclosure, in which each test pad 220 omits or excludes a segment along its length (e.g., tongue or finger) that is physically separable from the support layer 210 which carries the test pad 220. Rather, the length and width of each test pad 220 are contiguous with the support material 210. More particularly, in various embodiments each test pad 220 is formed as a predetermined length of the elongate support material 210, and is entirely integral with the support material 210 along the test pad's entire length and width.

A predetermined portion or section (e.g., a middle region) of a first or outer surface of each test pad 220 forms the test pad's fluid sampling region 224, which is controllably positionable relative to a port 105 provided by a cartridge 100 in which the test tape 200 resides. As indicated in FIG. 7B, the fluid sampling region 224 of each test pad 220 is positionable relative to the port 105 such that the first/outer surface of the test pad 220 can receive a fluid sample, while a second/inner surface of the test pad 220 wraps/folds around and is retained against or adjacent to the set of sensors 130. The fluid sample is transported throughout at least portions of the test pad's length and width, and typically though the test pad's thickness, such that the sensor(s) 130 disposed opposite to the test pad's first/outer surface against or adjacent/proximate to the test pad's second/inner surface can measure the level of at least one analyte present in the fluid sample.

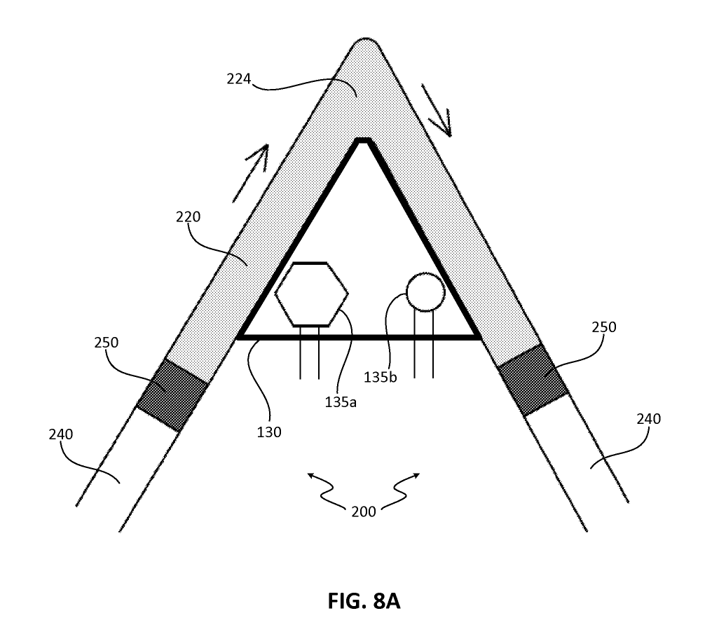

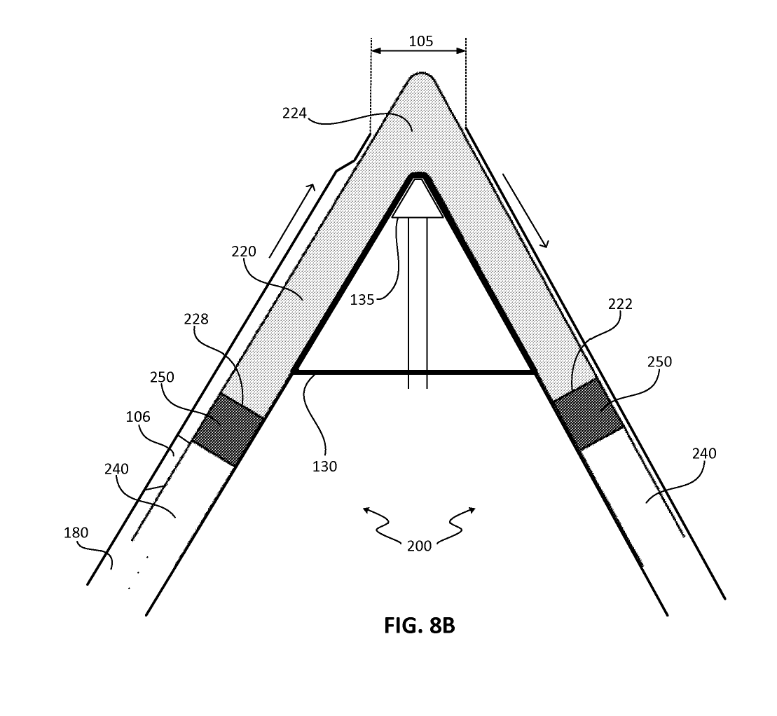

FIG. 8A is a schematic illustration of a representative multi-modal set of sensors 130 having multiple distinct types of sensors or sensing elements 135a,b, and a positioning of a representative test tape carrying test pads 220, cleanse-sealing pads 240, and separation members 250 relative thereto, in accordance with an embodiment of the present disclosure. In an embodiment, the set of sensors 130 includes a first subset of sensors or sensing elements 135a, and a second subset of sensors or sensing elements 135b. Each subset of sensing elements 135a,b is configured for measuring the level of a particular type of analyte in a fluid sample by way of a different or distinct type of sensing modality. For instance, the first subset of sensors 135a can be configured for electrochemical sensing; and the second subset of sensors 135b can be configured for electrochemiluminescent or another type of optical signal sensing (e.g., involving optical signal generation in addition to optical signal detection). One having ordinary skill in the relevant art will recognize that multi-modal sensors or sensing elements 135 can be structurally or positionally adapted for measuring fluid sample analyte levels in test pads 220 carried by various embodiments of cartridges 100 and/or test tapes 200 in accordance with the present disclosure.

FIG. 8B is a schematic illustration of a representative sensing element 135 and a positioning of the sensing element 135 relative to the port 105 of a cartridge 100 and a representative test tape carrying test pads 220, cleanse-sealing pads 240, and separation members 250 in accordance with another embodiment of the present disclosure. In this embodiment, at least a portion of the sensing element 135 is disposed within the spatial extent or cross sectional area of the port 105. For instance, the sensing element 135 can be centrally or approximately centrally disposed relative to the cross sectional area of the port 105. In such an embodiment, the fluid sampling region 224 of each test pad 220 need not be located at a terminal (e.g., front or first) end of the test pad 220, but rather is disposed between the test pad's front/first end 222 and trailing/second end 228. For instance, the fluid sampling region 224 can be disposed approximately midway between the test pad's first and second ends 222, 228. A fluid sample received by such a test pad's fluid sampling region 224 need only be transported through the thickness of the test pad 220, and need not be transported throughout the entire length and width of the test pad 220. Additionally, each test pad 220 can have a short(er) length in such an embodiment. Consequently, in embodiments analogous or corresponding to that shown in FIG. 8B, the test pad's fluid sampling region 224 resides within (e.g., approximately in the middle of) the test pad's active area/analyte measurement region 230; or the fluid sampling region 224 and the active area/analyte measurement region 230 are the same or essentially the same, in which case the fluid sampling region 224 can be loaded with an analyte in a manner analogous to that described above for the active area/analyte measurement region 230.

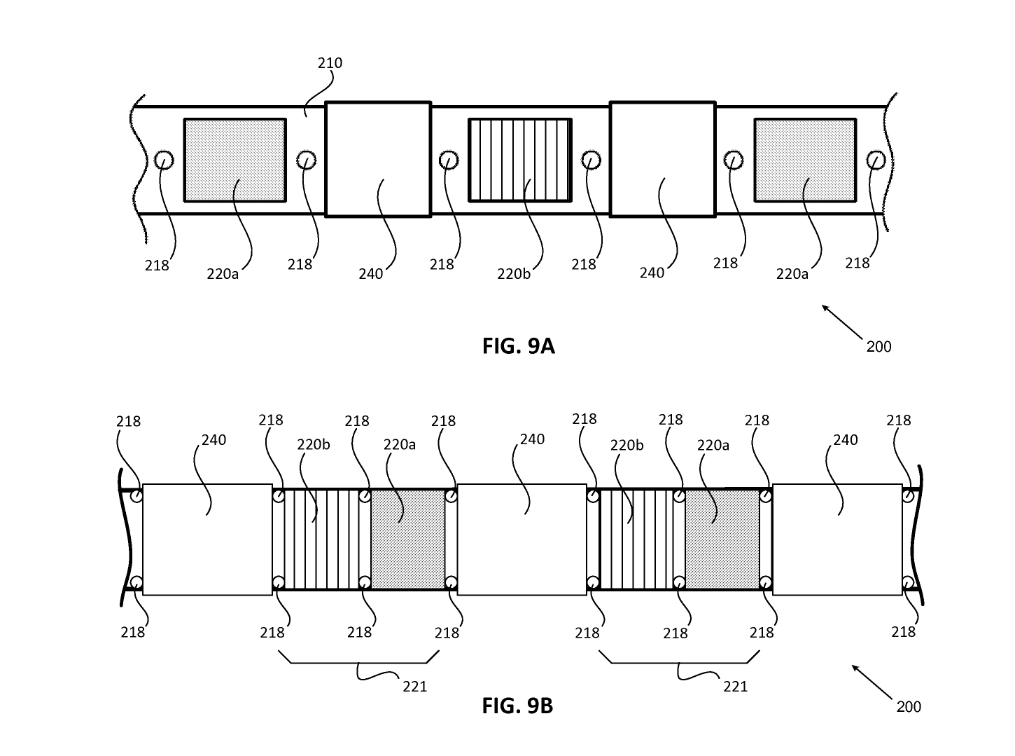

FIG. 9A is a schematic illustration of a continuous medium in the form of a multi-analyte test tape 200 carrying test pads 220 configured for measuring different or multiple types of analytes in accordance with an embodiment of the present disclosure. In an embodiment, the test tape 200 includes a first set of test pads 220a a second set of test pads 220b that is distinct or distinguishable from the first set of test pads 220a and a set of cleanse-sealing pads 240. Each cleanse-sealing pad 240 is disposed between an individual first test pad 220a and an individual second test pad 220b. An alternate embodiment could include cleanse pads 240 and dedicated sealing pads 260, in a manner analogous to that previously described.

Each individual test pad 220a within the first set of test pads 220a carries a first set of reagents directed to measuring the level of a first analyte within a first fluid sample. Analogously, each individual test pad 220b within the second set of test pads 220b carries a second set of reagents directed to measuring the level of a second analyte within a second fluid sample, where the second analyte is different than the first analyte. For instance, the first set of reagents can be directed to measuring blood glucose levels; and the second set of reagents can be directed to measuring cholesterol levels.

The number of test pads 220 in each of the first and second sets of test pads 220a,b can be selected or predetermined in accordance with embodiment details and/or intended use instructions/guidelines. For instance, the first set of test pads 220a can include multiple or many individual first test pads 220a (e.g., 10-25, 50, or 100 first test pads 220a); and the second set of test pads 220b can include a single or multiple/several individual second test pads 220b (e.g., 1-5 or 10 second test pads 220b), in accordance with an intended frequency or temporal interval at which the first and second analyte levels are intended/recommended to be measured.

In some embodiments, a cartridge 100 in which the multi-analyte test tape 200 resides can include a memory which stores information indicating at which test pad positions/locations along the multi-analyte test tape 200 each given type of test pad 220a, 220b resides; and possibly an electronic counter such that the type of test pad 220a,b that is currently aligned with a port 105 provided by the cartridge 100 can be determined and/or indicated to a user. In other embodiments, a portion of each test pad 220a,b can be color coded, such that an optical test pad characterization device or element (e.g., which includes an LED and a photodiode) can determine the type of test pad 220a,b that is currently positioned at the port 105. Notification of the type of test pad 220a,b that resides at the port 105, or equivalently, notification of the type of analyte measurement that the analyte measurement device 50 into which the cartridge 100 is inserted will perform, can be provided to a user by way of an LCD display 54 and/or an audio signal.

In addition or as an alternative to the foregoing, in some embodiments that include a multi-modal set of sensors 130, an individual test pad 220 can carry multiple non-interfering reagents within its active area/analyte measurement region 230. Each such non-interfering reagent can react with the same analyte by way of a different, non-interfering reaction mechanism or analyte level indication mechanism. Thus, in some embodiments, some or all test pads 220 are multi-reagent test pads 220 which provide a plurality of reagents for measuring the level of an identical analyte within fluid samples. When a multi-reagent test pad 220 is exposed to a fluid sample, a first sensor or sensing element 135a can measure the level of the analyte by way of a first reaction mechanism and a first sensing modality, and a second sensor or sensing element 135b can measure the level of this analyte by way of a second reaction mechanism and a second sensing modality. In such a manner, multiple or redundant measurements of the level of this analyte within the fluid sample can occur, which may enhance measurement reliability or accuracy. A nonlimiting representative example of such a non-interfering reagent combination for detection and measurement of glucose involves a first reagent including glucose oxidase plus mediator potassium ferricyanide (III), for electrochemical detection; and a second reagent including galactose/glucose binding protein (GGBP) and sensitive derivatives of the phenoxazine dye Nile Red, for fluorescent biosensor detection by way of optical/fluorometric sensing.

A continuous medium such as a test tape 200 can exhibit many types of test pad and/or cleanse pad/cleanse-sealing pad/dedicated sealing pad configurations depending upon embodiment details. For instance, FIG. 9B is a schematic illustration of a continuous medium in the form of a test tape 200 carrying a plurality of test pad pairs 221 separated by cleanse-sealing pads 240. Any given test pad pair 221 includes a first test pad 220a and a second test pad 220b, where each test pad pair 221 or the first and second test pads 220a,b therein can carry identical or different reagents. One having ordinary skill in the relevant art will recognize that other test pad, cleanse pad, cleanse-sealing pad, and/or dedicated sealing pad configurations are also possible within the scope of the present disclosure, such as test pad triplets, cleanse pad or cleanse-sealing pairs, or a continuous medium that carries only test pads 220 in accordance with a predetermined test pad organization, and which includes sealing pads 260, but which excludes cleanse pads 240.

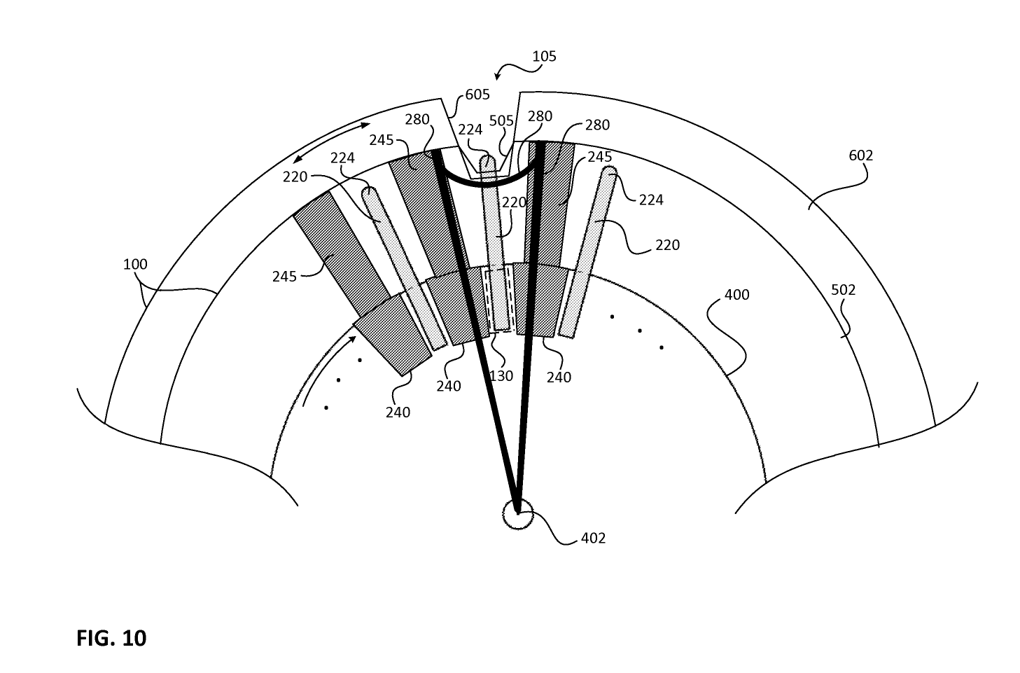

FIG. 10 is a schematic illustration of a continuous medium in the form of a disk 400 that carries test pads 220 and cleanse pads 240 in accordance with an embodiment of the present disclosure. In an embodiment, the disk 400 includes or is a rigid or substantially rigid support medium or substrate that carries test pads 220 and cleanse-sealing pads 240 in an alternating sequence relative to each other (e.g., in a manner analogous to certain other embodiments described herein) about or around the outer edge or periphery of the disk 400. Test pads 220 and cleanse-sealing pads 240 can be secured to an outer (e.g., upper or lower) surface of the disk 400, such as by way of an adhesive material or film. Each test pad 220 can radially protrude away from a center point or central aperture 402 of the disk 400, such that a fluid sampling region 224 of each test pad 220 is disposed at a predetermined distance away from the disk's periphery, or equivalently, a predetermined radius away from the disk's center point 402. Similarly, each cleanse-sealing pad 240 can radially extend away from the center point/aperture 402 of the disk 400, and can include a cleanse-sealing pad projection 245 that extends past the outer edge of the disk 400, and which is configured to interface with a set of sealing elements 280 as further detailed below.

A cartridge 100 in which the disk 400 resides can include a first housing 502 that overlays or surrounds the disk 400, the test pads 220, the cleanse-sealing pads 240, and a set of sensors 130 disposed within the first housing 502 for measuring the level of one or more analytes in a fluid sample to which any given test pad 220 is exposed. The set of sensors 130 can be carried by or disposed on a predetermined inner surface of the first housing 502. The first housing 502 includes a first access aperture 505 therein (e.g., formed on a top side or a bottom side of the first housing 502), relative to which each test pad's fluid sampling region 224 can be controllably and selectively/selectably positioned by way of mechanically indexing the disk 400 in a forward advancement, displacement, or rotation direction (which is indicated in FIG. 10 by an arrow on the disk 400) about its center point 402.

In a manner analogous to that described for other embodiments, internal portions of the first housing 502, portions of the disk 400, the cleanse-sealing pads 240, and/or other elements or structures can carry sealing features including a set of sealing elements 280 configured for engaging with cleanse-sealing pads 240 and cleanse-sealing pad projections 245 to form a hermetic seal that isolates fresh/unused test pads 220 from the cartridge's external environment. Such sealing elements 280 can include one or more types of elements previously described (e.g., protrusions and/or other types of structural barriers), roller elements (e.g., paired foam based or foam covered rollers that can form a fluid impermeable seal through which at least substantially rigid test pads 220, cleanse-sealing pads 240, and cleanse-sealing pad projections 245 can be rotationally advanced in the forward motion direction as a result of corresponding disk rotation), and/or other types of elements. Internal portions of the first housing 502 can also carry a set of desiccants, in a manner analogous to that previously described.

The cartridge 100 further includes a second housing 602 that overlays or surrounds the first housing 502. The second housing 602 includes a second access aperture 605 therein that can be selectively/selectably and controllably aligned with the first access aperture 505. Such selective alignment can occur by way of indexed ratchet motion, that is, indexed bidirectional motion (e.g., twisting) of the second housing 602 back and forth relative to the first housing 502 across a predetermined angular span or arc length. Such bidirectional motion is indicated in FIG. 10 by a double-headed arrow on the second housing 602.

When a test pad's fluid sampling region 224 is aligned with the first access aperture 505, and the first access aperture 505 is aligned with the second access aperture 605, the test pad's fluid sampling region 224 is exposed to the cartridge's external environment (and can receive a fluid sample). Taken together, the first access aperture 505 and the second access aperture 605 form the cartridge's port 105 when they are aligned to expose the test pad's fluid sampling region 224 to the cartridge's external environment. In this type of embodiment, the port 105 can be selectively and controllably opened or closed by way of relative bidirectional ratchet-type rotational motion between the second housing 602 and the first housing 502. Such motion can be provided by way of manual, semi-automatic, or automatic mechanisms.

When a test pad's fluid sampling region 224 is aligned with the port 105 and thus exposed to the cartridge's external environment, the cartridge 100 can be defined to be in a “test” position. After the test pad 220 has received a fluid sample and the sensor(s) 130 have measured the level of an analyte therein, displacement of the second housing 602 relative to the first housing 502 across a predetermined angular span in a backward direction results in misalignment of the second access aperture 605 relative to the first access aperture 505. Subsequent displacement of the second housing 602 relative to the first housing 502 in a forward motion direction results in (a) displacement of the test pad 220 along the forward disk rotation direction; (b) advancement of a cleanse-sealing pad 240 across the sensor(s) 130, such that the cleanse-sealing pad 240 wipes the sensor(s) 130 and the cleanse-sealing pad 240 and its corresponding cleanse-sealing pad projection 245 arrive at a “parked” position; and (c) re-alignment of the second access aperture 605 relative to the first access aperture 505. The cartridge 100 can then be defined to be in a “rest” position.

A user can successively transition the cartridge 100 from its rest position to its test position to thereby successively expose the fluid sampling regions 224 of fresh test pads 220 to the external environment of the cartridge 100, such that fluid samples can be received thereby for analyte level measurement. Each of the rest position and the test position can be associated with a characteristic indexing or alignment sound, for instance, a mechanical click, or an electronic tone or beep (which can differ for the rest and test positions), such that the user can more readily recognize whether the cartridge is in a “ready to use”/“ready-to-test state” or a “rest/no test” state.

In addition to the foregoing, the second housing 602 can include a cap (not shown) configured to having sealing elements (e.g., gasket elements) for facilitating hermetic isolation of fresh test pads 220 from the cartridge's external environment (e.g., in the event that the cartridge 100 is transitioned to the “ready-to-test” state, but a fluid sample is not yet available for application to the fluid sampling region 224 of the test pad 220 that is currently aligned with the port 105). Also, the second housing 602 can carry an LED screen that can display instructions/commands, test cartridge state, and/or analyte level measurement results (e.g., most-recent and historical measurement results).

Aspects of particular embodiments of the present disclosure address at least one aspect, problem, limitation, and/or disadvantage associated with exiting systems, apparatuses, devices, media, and techniques for analyte level measurement in biological fluid samples. While features, aspects, and/or advantages associated with certain embodiments have been described in this disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, apparatuses, devices, components, materials, media or alternatives thereof may be combined into other different systems, apparatuses, devices, components, materials, or media, for purposes/applications indicated herein or other applications. In addition, various modifications, alterations, and/or improvements may be made to various embodiments disclosed herein, which fall within the scope of the present disclosure.

1. A test medium for a biological fluid analyte measurement device, the test medium comprising:
a support medium;
a plurality of test pads disposed along the support medium, each test pad comprising a thin layer of a fluid transporting material having a length that is continuous between a first end and a second end of the test pad, a width, a thickness, and a cross sectional area defined by the width and the thickness of the test pad, the layer of the fluid transporting material of each of the plurality of test pads comprising at least one of:
a fluid sampling region configured for receiving a small volume of a biological fluid sample; and
at least one analyte measurement region fluidically coupled to the fluid sampling region, the at least one analyte measurement region having a length,
wherein the fluid sampling region or the at least one analyte measurement region carries at least one reagent capable of reacting with an analyte that is expected to be present within the fluid sample; and
a plurality of hermetic isolation pads disposed along the support medium such that each of the plurality of hermetic isolation pads is located between a pair of test pads, each of the plurality of hermetic isolation pads comprising a fluid impermeable material, each of the plurality of hermetic isolation pads having a length between a first end and a second end of the hermetic isolation pad, a width, a thickness, and a cross sectional area defined by the width and the thickness of the hermetic isolation pad, wherein the cross sectional area of each of the plurality of hermetic isolation pads is greater than or equal to the cross sectional area of each of the plurality of test pads.

2. The test medium of claim 1, wherein the at least one analyte comprises blood glucose or blood cholesterol.

3. The test medium of claim 1, wherein the fluid transporting material of each of the plurality of test pads is configured for transporting a distinct fluid sample substantially throughout the entire thickness of the fluid transporting material in the fluid sampling region of the test pad.

4. The test medium of claim 1, wherein the fluid transporting material of each of the plurality of test pads is configured for transporting a distinct fluid sample substantially throughout the entire length of the analyte measurement region of the test pad.

5. The test medium of claim 1, wherein the fluid transporting material of each of the plurality of test pads is configured for transporting a distinct fluid sample substantially throughout the entire test pad.

6. The test medium of claim 1, wherein the fluid sampling region of each of the plurality of test pads has a length that spans a predetermined fraction of the test pad length away from the first end of the test pad.

7. The test medium of claim 1, wherein the fluid sampling region of each of the plurality of test pads has a length that spans a predetermined fraction of the test pad length in a segment of the test pad between the first end of the test pad and the second end of the test pad.

8. The test medium of claim 1, wherein each of the plurality of hermetic isolation pads comprises a cleanse-sealing pad including a material configured for wiping, absorbing, or wicking portions of a distinct fluid sample away from a surface or structure when wiped across the surface or structure, and wherein each cleanse-sealing pad is disposed adjacent to a test pad.

9. The test medium of claim 1, further comprising a plurality of cleanse pads distinct from the plurality of hermetic isolation pads, each of the plurality of cleanse pads including a material configured for wiping, absorbing, or wicking portions of a distinct fluid sample away from a surface or structure when wiped across the surface or structure, wherein each cleanse pad is disposed adjacent to a test pad and adjacent to a hermetic isolation pad.

10. The test medium of claim 1, wherein the plurality of test pads comprises a first set of test pads and a second set of test pads distinct from the first set of test pads, each test pad within the first set of test pads carrying a first reagent capable of reacting with a first analyte that is expected to be present within the fluid sample, and each test pad within the second set of test pads carrying a second reagent capable of reacting with a second analyte that is expected to be present within the fluid sample and which is different than the first analyte.

11. The test medium of claim 10, wherein the number of test pads within the first set of test pads significantly exceeds the number of test pads within the second set of test pads.

12. The test medium of claim 1, wherein each test pad within the plurality of test pads carries a first reagent capable of reacting with a first analyte and a second reagent capable of reacting with a second analyte different than the first analyte.

13. The test medium of claim 1, wherein the support medium comprises an elongate tape structure.

14. The test medium of claim 13, wherein the tape structure comprises:
a continuous length of the fluid transporting material between at least a first test pad and a last test pad of the plurality of test pads; and
a plurality of separation elements, each of the plurality of separation elements positioned between a pair of test pads, and each of the plurality of separation elements comprising a portion of the fluid transporting material that has been rendered fluid nontransporting or hydrophobic.

15. The test medium of claim 13, wherein the tape structure comprises a support layer having a continuous length between at least a first test pad and a last test pad of the plurality of test pads, and wherein each of the plurality of test pads and each of the plurality of hermetic isolation pads is disposed on the support medium.

16. The test medium of claim 15, wherein the support layer includes a first side and a second side along its length, and wherein the first side of the support layer carries an adhesive film to which at least a portion of each of the plurality of test pads is adhered.

17. The test medium of claim 15, wherein the elongate tape structure carries (a) a plurality of cleanse pads and/or cleanse-sealing pads disposed directly adjacent one another along a terminal end section of the elongate tape structure, or (b) an extended length cleanse pad or cleanse-sealing pad disposed at the terminal end section of the elongate tape structure.

18. The test medium of claim 1, wherein the fluid sampling region of each of the plurality of test pads is not adhered to the support medium, and wherein the analyte measurement region of each of the plurality of test pads is adhered to the support medium.

19. The test medium of claim 1, wherein the support medium comprises a structure having a circular profile or cross section.

20. The test medium of claim 1, wherein the support medium includes a plurality of indexing holes, each of the plurality of indexing holes configured for receiving an indexing pin.

21. A test medium for a biological fluid analyte measurement device, the test medium comprising:
a support medium;
a plurality of test pads disposed along the support medium, each test pad comprising a thin layer of a fluid transporting material having a length that is continuous between a first end and a second end of the test pad, a width, a thickness, and a cross sectional area defined by the width and the thickness of the test pad, the layer of the fluid transporting material of each of the plurality of test pads comprising at least one of:
a fluid sampling region configured for receiving a small volume of a biological fluid sample; and
at least one analyte measurement region fluidically coupled to the fluid sampling region, the at least one analyte measurement region having a length,
wherein the fluid sampling region or the at least one analyte measurement region is pre-loaded with at least one reagent capable of reacting with an analyte that is expected to be present within the fluid sample; and
a plurality of cleanse pads disposed along the support medium such that each of the plurality of cleanse pads is located between a pair of test pads, each of the plurality of cleanse pads having a length between a first end and a second end of the cleanse pad, a width, a thickness, and a cross sectional area defined by the width and the thickness of the cleanse pad, wherein the cross sectional area of each of the plurality of cleanse pads is greater than or equal to the cross sectional area of each of the plurality of test pads., wherein each of the plurality of cleanse pads is not pre-loaded with the at least one reagent, and wherein each of the plurality of cleanse pads comprises a material capable of wiping, absorbing, or wicking portions of the distinct fluid sample away from a surface corresponding to a set of sensors when wiped across the surface corresponding to the set of sensors in association with displacement of the support medium in a forward motion direction,
wherein the support medium comprises (a) a structure to which portions of test pads and cleanse pads are adhered, or (b) a structure made from the fluid transporting material and which has been rendered fluid nontransporting or hydrophobic at predetermined locations.

22. A replaceable cartridge for a biological analyte measurement device, the replaceable cartridge comprising:
a support medium displaceable in a forward motion direction by way of a set of mechanical drive elements;
a plurality of test pads disposed along the support medium, each of the plurality of test pads positionable relative to a set of sensors, each of the plurality of test pads comprising a thin layer of a fluid transporting material having a length that is continuous between a first end and a second end of the test pad, a width, a thickness, and a cross sectional area defined by the width and the thickness of the test pad, the layer of the fluid transporting material of each of the plurality of test pads comprising at least one of:
a fluid sampling region configured for receiving a small volume of a biological fluid sample; and
at least one analyte measurement region corresponding to the fluid sampling region and carrying at least one reagent capable of reacting with an analyte that is expected to be present within the fluid sample, the at least one analyte measurement region having a length,
wherein the fluid sampling region or the at least one analyte measurement region carries at least one reagent capable of reacting with an analyte that is expected to be present within the fluid sample; and
a plurality of hermetic isolation pads disposed along the support medium such that each of the plurality of hermetic isolation pads is located between a pair of test pads, each of the plurality of hermetic isolation pads comprising a fluid impermeable material, each of the plurality of hermetic isolation pads having a length between a first end and a second end of the hermetic isolation pad, a width, a thickness, and a cross sectional area defined by the width and the thickness of the hermetic isolation pad, wherein the cross sectional area of each of the plurality of hermetic isolation pads is greater than or equal to the cross sectional area of each of the plurality of test pads; and
a housing in which the support medium resides and which is configured for removable engagement with the analyte measurement device, the housing comprising:
a plurality of internal surfaces providing a primary channel having a primary cross sectional area through which the support medium, each of the plurality of test pads, and each of the plurality of hermetic isolation pads are displaceable;
at least one set of sealing elements that occupies a portion of the primary cross sectional area along a portion of the primary channel to define a secondary channel through which the support medium, each of the plurality of test pads, and each of the plurality of hermetic isolation pads are displaceable, the secondary channel having a secondary cross sectional area smaller than the primary cross sectional area, wherein the at least one set of sealing elements is engageable with each of the plurality of hermetic isolation pads when the hermetic isolation pad is displaced through portions of the secondary channel; and
a port through which each of the plurality of test pads is exposable to an environment external to the housing,
wherein engagement of a hermetic isolation pad of the plurality of hermetic isolation pads with the at least one set of sealing elements enables the formation of a hermetic seal within the housing that isolates portions of the primary channel from the environment external to the housing.

23. The replaceable cartridge of claim 22, wherein the at least one set of sealing elements includes a first set of sealing elements disposed proximate to the port and/or the set of sensors.

24. The replaceable cartridge of claim 22, wherein the at least one set of sealing elements comprises a first set of sealing elements disposed at a first predetermined location relative to the primary channel, and a second set of sealing elements disposed at a second predetermined location relative to the primary channel, wherein the first set of sealing elements resides closer to the port than the second set of sealing elements.

25. The replaceable cartridge of claim 24, wherein the first set of sealing elements is configured for engaging with a first hermetic isolation element of the plurality of hermetic isolation elements, and wherein the second set of sealing elements is configured for engaging with a second hermetic isolation element of the plurality of hermetic isolation elements distinct from the first hermetic isolation element.

26. The replaceable cartridge of claim 22, further comprising a set of sensors carried by the housing, the set of sensors configured for detecting the presence or level of at least one analyte within a distinct fluid sample transported from the fluid sampling region of a test pad of the plurality of test pads into the at least one analyte measurement region of the test pad.

27. The replaceable cartridge of claim 26, wherein each of the plurality of hermetic isolation pads comprises a cleanse-sealing pad disposed adjacent to a test pad, each of the cleanse-sealing pads including a material configured for wiping, absorbing, or wicking portions of the distinct fluid sample away from a surface corresponding to the set of sensors when wiped across the surface corresponding to the set of sensors.

28. The replaceable cartridge of claim 26, further comprising a plurality of cleanse pads distinct form the plurality of hermetic isolation pads, each of the plurality of cleanse pads disposed adjacent to a test pad and adjacent to a hermetic isolation pad, each of the plurality of cleanse pads including a material configured for wiping, absorbing, or wicking portions of a distinct fluid sample away from a surface corresponding to the set of sensors when wiped across the surface corresponding to the set of sensors.

29. The replaceable cartridge of claim 26, wherein the cartridge, including the set of sensors carried thereby, is disposable.

30. The replaceable cartridge of claim 26, wherein the set of sensors includes at least one of an electrochemical sensor, an electrochemiluminescence sensor, and an optical sensor.

31. The replaceable cartridge of claim 26, wherein the set of sensors includes a first sensor and a second sensor that operates in accordance with a different sensing modality than the first sensor.

32. The replaceable cartridge of claim 22, further comprising at least one desiccant material disposed within the housing.

33. The replaceable cartridge of claim 22, wherein the support medium comprises an elongate tape structure or a structure having a circular profile or cross section.

34. The replaceable cartridge of claim 22, wherein the cartridge is configured for indexed displacement in the forward motion direction by way of the set of mechanical drive elements.

35. The replaceable cartridge of claim 34, wherein the cartridge carries passive mechanical drive elements and excludes active mechanical drive elements configured to drive the passive drive elements.

36. The replaceable cartridge of claim 34, wherein the support medium comprise an elongate tape structure, and wherein the replaceable cartridge further comprises a source compartment in which test pads of the plurality of test pads that have not been exposed to the external environment reside, and a destination compartment in which test pads of the plurality of test pads that have been exposed to the external environment reside.

37. The replaceable cartridge of claim 36, wherein successive indexed displacement of the support medium in the forward motion direction successively transfers test pads from the source compartment into the primary channel of the replaceable cartridge.

38. The replaceable cartridge of claim 36, further comprising a destination spool disposed in the destination compartment, around which the tape structure can be wound in association with displacement of the tape structure in the forward motion direction.

39. The replaceable cartridge of claim 36, further comprising a source spool disposed in the source compartment, around which the tape structure is wound and from which the tape structure can be fed into the primary channel of the replaceable cartridge in association with displacement of the tape structure in the forward direction.
